(19) United States
(12) Patent Application Publication
(10) Pub. No.: US 2022/0186030 A1
(43) Pub. Date: Jun. 16, 2022

(54) (CO)POLYMER MATRIX COMPOSITES COMPRISING THERMALLY-CONDUCTIVE PARTICLES AND A NONVOLATILE DILUENT AND METHODS OF MAKING THE SAME

(71) Applicant: 3M INNOVATIVE PROPERTIES COMPANY, St. Paul, MN (US)

(72) Inventors: Sebastian Goris, Inver Grove Heights, MN (US); Derek J. Dehn, Maplewood, MN (US); Paul T. Hines, St. Paul, MN (US); Clinton P. Waller, Jr., White Bear Lake, MN (US); Mario A. Perez, Burnsville, MN (US); Bharat R. Acharya, Woodbury, MN (US); Ronald W. Ausen, St. Paul, MN (US)

(21) Appl. No.: 17/595,071

(22) PCT Filed: May 7, 2020
(86) PCT No.: PCT/IB2020/054333

§ 371 Date: Nov. 8, 2021

Related U.S. Application Data
(60) Provisional application No. 62/848,381, filed on May 15, 2019.

(51) Int. Cl. C08L 91/00; C08J 9/28; C08J 9/00; C08L 91/08; C08J 9/38; C09K 5/14

(52) U.S. Cl. CPC C08L 91/00; C08J 9/28; C08J 9/0066; C08L 91/08; C08J 9/38; C08J 2201/0522; C08L 2207/068; C08J 2391/00; C08J 2391/08; C08J 2423/04; C09K 5/14

(57) ABSTRACT

(Co)polymer matrix composites including a porous (co)polymeric network; a nonvolatile diluent, and a multiplicity of thermally-conductive particles distributed within the (co)polymeric network; wherein the thermally-conductive particles are present in a range from 15 to 99 weight percent, based on the total weight of the (co)polymer matrix (including the thermally-conductive particles and the nonvolatile diluent). Optionally, the (co)polymer matrix composite volumetrically expands by at least 10% of its initial volume when exposed to a temperature of at least 135° C. Methods of making and using the (co)polymer matrix composites are also disclosed. The (co)polymer matrix composites are useful, for example, as heat dissipating or heat absorbing articles, as fillers, thermal interface materials, and thermal management materials, for example, in electronic devices, more particularly mobile handheld electronic devices, power supplies, and batteries.

### BACKGROUND

Integrated circuits, active and passive components, optical disk drives, batteries, sensors and motors generate heat during use. To prolong the long term, as well as continuous, use of the devices, the heat must be dissipated. Finned metal blocks and heat spreaders containing heat pipes are commonly used as heat sinks to dissipate the heat generated by devices during use. Materials commonly used for providing a thermal bridge between the heat generating components and heat sinks/heat spreaders include gel masses, liquid to solid phase change compounds, greases, and pads that are mechanically clamped between, for example, a printed circuit board (PCB) and heat sink. These articles are commonly referred to as Thermal Interface Materials (TIMs).

Managing charging and discharging of battery systems is often done via electronic battery management systems. Thermal management is often done via heat transfer materials and combinations of both active and passive cooling with air or heat transfer liquid interfaces.

Thermally-conductive materials, incorporated into adhesives (e.g., heat-activated, hot-melt and pressure-sensitive adhesives) are sometimes used to provide an adhesive bond between a heat generating component and a heat sink/heat spreader so that no mechanical clamping is required. Such thermal interface materials often exhibit good heat conduction characteristics compared to unfilled or lightly filled adhesive compositions, but may not exhibit good heat absorption or heat dissipation characteristics compared to metal heat sinks or heat spreader. Thermal management is often done via heat transfer materials and combinations of both active and passive cooling with air or conductive heat transfer to liquid-cooled interfaces.

Porous films and membranes foams are generally made via a phase separation process, and therefore typically have relatively small, uniform, pore sizes, and different pore morphologies as compared to foams. The pores on porous films are typically open such that gas, liquid, or vapor can pass from one major surface though the open pores to the other opposed, major surface. Porous films and membranes foams can be made via several phase separation processes, but are typically made via nonvolatile diluent induced phase separation or thermally induced phase separation.

### SUMMARY

Porous (co)polymeric films generally have high flexibility and can provide intimate contact or cushioning between hard plastics or metal. Trapped air, however, is naturally considered an insulator against heat conduction, and porous materials featuring trapped air are typically not suitable for heat dissipation. Alternative lightweight, flexible materials and approaches for conducting, absorbing and/or dissipating heat, particularly in compact (e.g., handheld) electronic devices are desired.

The present disclosure describes various exemplary embodiments of highly particle-loaded (co)polymer matrix composites which exhibit high thermal conductivity and are useful as thermal interface materials. The present disclosure also describes processes to manufacture a (co)polymer matrix composite including a plurality of thermally-conductive particles distributed within the (co)polymer matrix, wherein the (co)polymer matrix is formed into a porous film through phase separation of the (co)polymer from a nonvolatile diluent.

Thus, in one aspect, the present disclosure describes a (co)polymer matrix composite including:

a porous (co)polymeric network structure, a nonvolatile diluent, and a plurality of thermally-conductive particles distributed within the (co)polymeric network structure, wherein the thermally-conductive particles are present in a range from 15 to 99 (in some embodiments, in a range from 25 to 98, 30 to 95, 35 to 90, or even 40 to 85) weight percent, based on the total weight of the (co)polymer matrix composite (including the nonvolatile diluent).

In some exemplary embodiments, the (co)polymer matrix composite volumetrically expands by at least 10% (in some embodiments at least 20%, 30%, 40% or even 50%) of its initial volume when exposed to a temperature of at least 135 (in some embodiments, at least 150, 175, or even at least 200; in some embodiments, in a range from 135 to 400, or even 200 to 400) ° C.

In some such embodiments, the percent volume expansion of the (co)polymeric matrix composites is improved by compressing the (co)polymeric matrix composite, thereby increasing the density of the unexpanded (co)polymer matrix composite.

In certain exemplary embodiments, the (co)polymer matrix composite is a highly particle loaded porous polyethylene article (film) having good toughness, high impact strength, and excellent abrasion resistance with little or no particle shedding.

In another aspect, the present disclosure describes a method of making (co)polymer matrix composites described herein, the method including combining (e.g., mixing or blending) a thermoplastic (co)polymer, a nonvolatile diluent, and a plurality of thermally-conductive particles to form a slurry; forming the slurry into an article (e.g., a layer); heating the article to a temperature above the melting temperature of the (co)polymer in the nonvolatile diluent in an environment so that the (co)polymer becomes miscible with nonvolatile diluent (e.g., forms a solution of the (co)polymer dissolved in the nonvolatile diluent) while retaining at least 90 (in some embodiments, at least 91, 92, 93, 94, 95, 96, 97, 98, 99, 99.5, or even 100) percent by weight of the nonvolatile diluent in the article, based on the weight of the nonvolatile diluent in the article, and solubilize at least 50 (in some embodiments, at least 55, 60, 65, 70, 75, 80, 85, 90, 95, 96, 97, 98, 99, or even 100) percent of the thermoplastic (co)polymer in the nonvolatile diluent, based on the total weight of the thermoplastic (co)polymer; and cooling the article to a temperature below the melting temperature of the (co)polymer in the nonvolatile diluent to induce phase separation of the thermoplastic (co)polymer from the nonvolatile diluent to provide the (co)polymer matrix composite containing the thermally-conductive particles and at least a portion of the nonvolatile diluent. In certain exemplary embodiments, at least 50%, 60%, 70%, 80%, 90%, 05%, 99% or even 99.5% by weight of the nonvolatile diluent added to the (co)polymer matrix composite is retained in the (co)polymer matrix composite after cooling. Preferably, substantially all of the nonvolatile diluent is retained in the (co)polymer matrix composites.

In an additional aspect, the present disclosure describes another method of making (co)polymer matrix composites described herein, the method including combining (e.g., mixing or blending) a thermoplastic (co)polymer and a nonvolatile diluent for the thermoplastic (co)polymer to form a mixture, heating the mixture to a temperature above the melting temperature of the (co)polymer in the nonvolatile diluent to form a miscible thermoplastic (co)polymer-nonvolatile diluent solution; combining (e.g., mixing or blending) with the solution a plurality of thermally-conductive particles to form a suspension of the thermally-conductive particles in the solution; forming the suspension into an article (e.g., a layer); and cooling the article below the melting temperature of the (co)polymer in the nonvolatile diluent to induce phase separation of the thermoplastic (co)polymer from the nonvolatile diluent and form the (co)polymer matrix composite containing the thermally-a conductive particles and the majority of the nonvolatile diluent. Alternatively, the thermally-conductive particles can be added to the (co)polymer and nonvolatile diluent prior to heating the mixture.

In one particular advantageous embodiment, the method includes forming a substantially homogenous solution of ultra-high molecular weight polyethylene (UHMWPE) polymer having a molecular weight greater than 1,000,000 in a nonvolatile diluent (e.g., mineral oil or paraffin wax). A paste or slurry is formed by combining the UHMWPE polymer, the nonvolatile diluent and a plurality of thermally-conductive particles, forming the paste or slurry into a formed object having a desired shape at room temperature (e.g., by adding the slurry to a mold), heating the formed object to a temperature above the melting temperature of the UHMWPE and maintaining the slurry at a temperature above the melting temperature of the UHMWPE for a time sufficient for the UHMWPE polymer particles to substantially dissolve in the nonvolatile diluent, and cooling the formed object to a temperature below the melting temperature of the UHMWPE, thereby resulting in phase separation of the polymer and nonvolatile diluent and locking the thermally-conductive particles in a porous polymer network. In certain presently-preferred embodiments, at least a portion of the nonvolatile diluent remains in the in the porous polymer network. Alternatively, the thermally-conductive particles can be added to the UHMWPE polymer and nonvolatile diluent prior to heating the mixture.

The (co)polymer matrix composites described herein may be useful, for example, as fillers, thermal interface materials, and thermal management materials, for example, in electronic devices, more particularly mobile handheld electronic devices, power supplies, and batteries.

### BRIEF DESCRIPTION OF THE DRAWINGS

The disclosure may be more completely understood by consideration of the following detailed description of various embodiments of the disclosure in connection with the accompanying figures, in which:

FIG. 1 is a schematic of an exemplary (co)polymer matrix composite described herein.

FIG. 2 is a schematic of another exemplary (co)polymer matrix composite described herein.

FIG. 3 is a schematic of another exemplary (co)polymer matrix composite described herein.

FIGS. 4A, 4B and 4C are schematic views of thermal interface materials, in which FIG. 4C illustrates exemplary (co)polymer matrix composites described herein.

FIG. 5 shows a scanning electron microscope (SEM) micrograph of a cross-section of an exemplary (co)polymer matrix composites (Example 4B) described herein.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. Therefore, it should be understood that:

The term “homogeneous” means exhibiting only a single phase of matter when observed at a macroscopic scale.

The terms “(co)polymer” or “(co)polymers” includes homopolymers and copolymers, as well as homopolymers or copolymers that may be formed in a miscible blend, e.g., by coextrusion or by reaction, including, e.g., transesterification. The term “copolymer” includes random, block and star (e.g., dendritic) copolymers.

The term “(meth)acrylate” with respect to a monomer, oligomer or means a vinyl-functional alkyl ester formed as the reaction product of an alcohol with an acrylic or a methacrylic acid.

The term “miscible” as used herein refers to the ability of substances to mix in all proportions (i.e., to fully dissolve in each other at any concentration), forming a solution, wherein for some nonvolatile diluent-(co)polymer systems heat may be needed for the (co)polymer to be miscible with the nonvolatile diluent. By contrast, substances are immiscible if a significant proportion does not form a solution. For example, butanone is significantly soluble in water, but these two nonvolatile diluents are not miscible because they are not soluble in all proportions.

The term “nonvolatile diluent” means a material that is capable of forming a substantially homogeneous solution with a selected (co)polymer at a temperature at or above the melting temperature of the (co)polymer, but which forms an immiscible phase-separated mixture with the (co)polymer and does not substantially undergo vaporization (e.g., exhibits a vapor pressure less than 1 mm Hg) at temperatures below the melting temperature of the (co)polymer.

The term “phase separation,” as used herein, refers to the process in which particles are uniformly dispersed in a homogeneous (co)polymer-nonvolatile diluent solution that is transformed (e.g., by a change in temperature or nonvolatile diluent concentration) into a continuous three-dimensional (co)polymer matrix composite.

The term “thermally-conductive particles,” as used herein, means particles having a thermal conductivity greater than 2 W/(m° K).

The term “adjacent” with reference to a particular layer means joined with or attached to another layer, in a position wherein the two layers are either next to (i.e., adjoined to) and directly contacting each other, or contiguous with each other but not in direct contact (i.e., there are one or more additional layers intervening between the layers).

Terms of orientation such as “atop”, “on”, “over,” “covering”, “uppermost”, “underlying” and the like for the location of various elements in the disclosed coated articles, refer to the relative position of an element with respect to a horizontally-disposed, upwardly-facing substrate. However, unless otherwise indicated, it is not intended that the substrate or articles should have any particular orientation in space during or after manufacture. For purposes of clarity and without intending to be unduly limited thereby, the tape sheets or strips in a group of any two sequentially stacked sheets or strips are referenced as an overlying tape sheet and an underlying tape sheet with the adhesive layer of the overlying tape sheet adhered to the front or first face of the backing of the underlying tape sheet.

The terms “overlay” or “overlaying” describe the position of a layer with respect to a substrate or layer of a multi-layer article of the present disclosure, we refer to the layer as being atop the substrate or other element, but not necessarily contiguous to either the substrate or the other element.

The term “separated by” to describe the position of a layer with respect to other layers, refers to the layer as being positioned between two other layers but not necessarily contiguous to or adjacent to either layer.

The terms “about” or “approximately” with reference to a numerical value or a shape means +/− five percent of the numerical value or property or characteristic, but expressly includes the exact numerical value. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g., visible light) than it fails to transmit (e.g., absorbs and reflects). Thus, a substrate that transmits more than 50% of the visible light incident upon its surface is substantially transparent, but a substrate that transmits 50% or less of the visible light incident upon its surface is not substantially transparent.

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g., 1 to 5 includes 1, 1.5, 2, 2.75, 3, 3.8, 4, and 5).

Unless otherwise noted, all parts, percentages, ratios, etc. used in the specification are expressed based on the weight of the ingredients. Weight percent, percent by weight, % by weight, wt. % and the like are synonyms that refer to the amount of a substance in a composition expressed as the weight of that substance divided by the weight of the composition and multiplied by 100.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments but is to be controlled by the limitations set forth in the claims and any equivalents thereof.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments but are to be controlled by the limitations set forth in the claims and any equivalents thereof.

### (Co)Polymer Matrix Composites

In one aspect, the present disclosure describes a (co)polymer matrix composite comprising:

a porous (co)polymeric network structure;

a nonvolatile diluent; and

a plurality of thermally-conductive particles distributed within the (co)polymeric network structure, wherein the thermally-conductive particles are present in a range from 15 to 99 (in some embodiments, in a range from 25 to 98, 30 to 95, 35 to 90, or even 40 to 85) weight percent, based on the total weight of the thermally-conductive particles and the (co)polymer (excluding any nonvolatile diluent).

In some exemplary embodiments, the (co)polymer matrix composite volumetrically expands by at least 10% (in some embodiments at least 20%, 30%, 40% or even 50%) of its initial volume when exposed to a temperature of at least 135 (in some embodiments, at least 150, 175, or even at least 200; in some embodiments, in a range from 135 to 400, or even 200 to 400) ° C.

In some such embodiments, the percent volume expansion of the (co)polymeric matrix composites is improved by compressing the (co)polymeric matrix composite, thereby increasing the density of the unexpanded (co)polymer matrix composite.

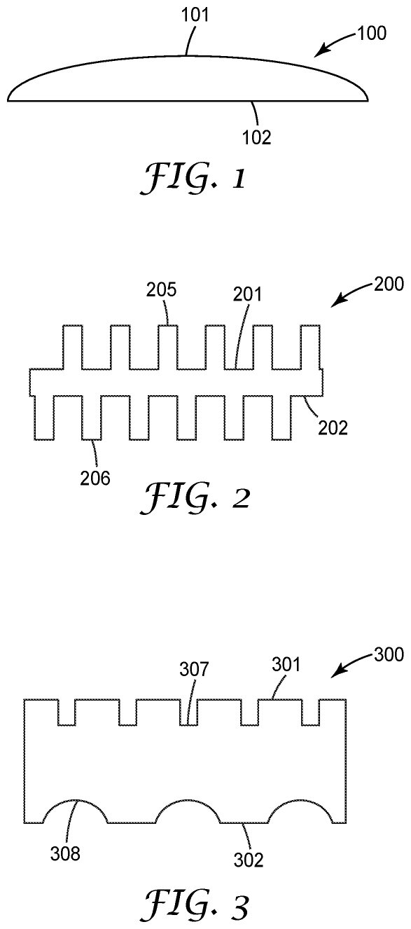

In certain exemplary embodiments, (co)polymeric matrix composites described herein, have first and second planar, opposed major surfaces. In some embodiments, (co)polymer matrix composites described herein, have first and second opposed major surfaces, wherein the first major surface is nonplanar (e.g., curved). Referring to FIG. 1, exemplary (co)polymer matrix composite described herein 100 has first and second opposed major surfaces 101, 102. First major surface 101 is nonplanar.

Planar and nonplanar major surfaces can be provided, for example, by coating or extruding the slurry onto a patterned substrate (e.g., a liner, a belt, a mold, or a tool). Alternatively, for example, a die with a shaped slot can be used to form nonplanar surfaces during the coating or extrusion process. Alternatively, for example, the structure can be formed after the phase separation has occurred before, and/or after, the nonvolatile diluent is removed by molding or shaping the layer with a patterned tool.

In some embodiments, (co)polymer matrix composites described herein, have first protrusions extending outwardly from the first major surface, and in some embodiments, second protrusions extending outwardly from the second major surface. In some embodiments, the first protrusions are integral with the first major surface, and in some embodiments, the second protrusions are integral with the second major surface. Exemplary protrusions include at least one of a post, a rail, a hook, a pyramid, a continuous rail, a continuous multi-directional rail, a hemisphere, a cylinder, or a multi-lobed cylinder. In some embodiments, the protrusions have a cross-section in at least one of a circle, a square, a rectangle, a triangle, a pentagon, other polygons, a sinusoidal, a herringbone, or a multi-lobe.

Referring to FIG. 2, exemplary (co)polymer matrix composite described herein 200 has first protrusions 205 extending outwardly from first major surface 201 and optional second protrusions 206 extending outwardly from second major surface 202.

Protrusions can be provided, for example, by coating or extruding between patterned substrate (e.g., a liner, a belt, a mold, or a tool). Alternatively, a die with a shaped slot can be used to form protrusions during the coating or extrusion process. Alternatively, for example, the structure can be formed after the phase separation has occurred by molding or shaping the film between patterned tools.

In some embodiments, (co)polymer matrix composite described herein, have first depressions extending into the first major surface, and in some embodiments, second depressions extending into the second major surface. Exemplary depressions include at least one of a groove, a slot, an inverted pyramid, a hole (including a thru or blind hole), or a dimple.

Referring to FIG. 3, exemplary (co)polymer matrix composite described herein 300 has first depressions 307 extending into first major surface 301 and optional second depressions 308 extending into second major surface 302. Depressions can be provided, for example, by coating or extruding between a patterned substrate (e.g., a liner, a belt, a mold, or a tool). Alternatively, for example, a die with a shaped slot can be used to form depressions during the coating or extrusion process. Alternatively, for example, the structure can be formed after the phase separation has occurred, before and/or after, the nonvolatile diluent is removed by molding or shaping the film between patterned tools.

In some exemplary embodiments, these shaped two- or three-dimensional structures can improve compression by deforming and or bending to provide increased compression and contact force between heat transfer surfaces. As heat transfer surfaces expand or contract this compression or spring like action created by the surfaces can improve thermal conductivity by improving surface to surface contact. Alternatively, increased surface area caused by certain shapes can increase convective heat transfer. This can be a benefit where heat is being conducted to a fluid or air rather than a second heat absorbing surface or heat sink.

In some exemplary embodiments, (co)polymer matrix composites described herein further comprise a reinforcement or support structure (e.g., attached to the (co)polymer matrix composite, partial therein, and/or therein). Exemplary reinforcements or support structures include fibers, strands, nonwovens, woven materials, fabrics, mesh, and films.

Reinforcement/support structures such as nonwovens, wovens, mesh, fibers, etc. can be imbibed with, laminated or adhered to thermally conductive polymer composites to help improve mechanical durability. In some embodiments it can be advantageous for these supports to also be thermally conductive. Thus, metal foils and meshes are particularly, useful as are carbon fibers, glass fibers, and or flame-resistant (co)polymeric fibers (e.g., oriented poly(acrylo)nitrile (OPAN) fibers or poly(phenylene)sulfide (PPS) fibers.

The reinforcement, for example, can be laminated to the (co)polymer matrix composite thermally, adhesively, or ultrasonically. The reinforcement, for example, can be imbedded within the (co)polymer matrix composite during the coating or extrusion process. The reinforcement, for example, can be between the major surfaces of the composite, on one major surface, or on both major surfaces.

More than one type of reinforcement can be used. (Co)polymer matrix composites described herein are useful, for example, as fillers, thermally activated fuses, and fire stop devices. For further details of fire stop devices in general, see, for example, U.S. Pat. No. 6,820,382 (Chambers et al.), the disclosure of which is incorporated herein by reference. For further details of fillers in general, see, for example, U.S. Pat. No. 6,458,418 (Langer et al.) and 8,080,210 (Hornback, III), the disclosures of which are incorporated herein by reference.

The (co)polymer matrix composites described herein may be useful, for example, as fillers, thermal interface materials, and thermal management materials, for example, in electronic devices, more particularly mobile handheld electronic devices, power supplies, and batteries.

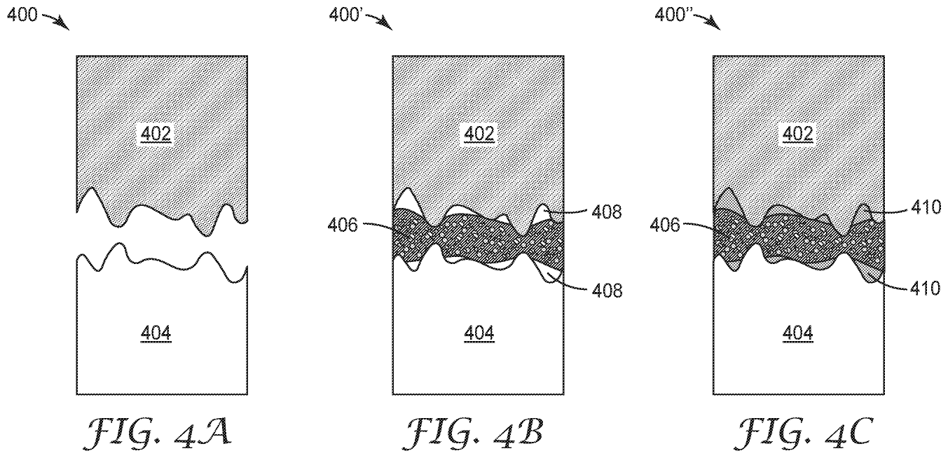

Turning now to FIG. 4A-4C, various alternatives for creating a thermal bridge with and without a thermal interface material are illustrated to highlight some of the advantages of embodiments of the (co)polymer matrix composites of the present disclosure. FIG. 4A illustrates a thermal bridge 400 created by contacting a heat source 402 (e.g., a battery module) with a heat sink 404 (e.g., cooling plate 404). Due to microscopic variations in the surface roughness of the contact interface between the heat source 402 and the heat sink 404, it is difficult if not impossible to maintain good thermal conductivity across the contact interfaces. Consequently, conductive heat transfer across the contact interface between the heat source 402 and the heat sink 404 is adversely affected.

FIG. 4B illustrates a thermal bridge 400 created by contacting a heat source 402 (e.g., a battery module) with a heat sink 404 (e.g., cooling plate 404) and a conventional thermal interface material 406 (e.g., an adhesive composition with a thermally-conductive filler). Although the presence of the thermal interface material 406 improves thermal coupling at the contact interface between the heat source 402 and the heat sink 404, microscopic porosity 408 (e.g., air voids) may still be created between the thermal interface 406 material and the heat source 402 and heat sink 404. Consequently, conductive heat transfer across the contact interface between the heat source 402 and the heat sink 404 is improved relative to FIG. 4A, but nevertheless not adversely affected.

FIG. 4C illustrates a thermal bridge 400 created by contacting a heat source 402 (e.g., a battery module) with a heat sink 404 (e.g., cooling plate 404) and a thermal interface material 406 made from the (co)polymer matrix composite according to the present disclosure. Thermal coupling across the contact interface is nearly perfect, as the nonvolatile diluent 410 is able to fill any air voids. Consequently, conductive heat transfer across the contact interface between the heat source 402 and the heat sink 404 is improved relative to FIGS. 4A and 4B.

The (co)polymeric network structure may be described as a porous (co)polymeric network or a porous phase-separated (co)polymeric network. Generally, the porous (co)polymeric network (as-made) includes an interconnected porous (co)polymeric network structure comprising a plurality of interconnected morphologies (e.g., at least one of fibrils, nodules, nodes, open cells, closed cells, leafy laces, strands, nodes, spheres, or honeycombs). The interconnected (co)polymeric structures may adhere directly to the surface of the particles and act as a binder for the particles. In this regard, the space between adjacent particles (e.g., particles or agglomerate particles) may include porous (co)polymeric network structures, as opposed to a solid matrix material, thereby providing desired porosity.

In some embodiments, the (co)polymeric network structure may include a 3-dimensional reticular structure that includes an interconnected network of (co)polymeric fibrils. In some embodiments, individual fibrils have an average width in a range from 10 nm to 100 nm (in some embodiments, in a range from 100 nm to 500 nm, or even 500 nm to 5 micrometers).

In some embodiments, the thermally-conductive particles, thermally-conductive particles and optional thermally-conductive particles are dispersed within the (co)polymeric network structure, such that an external surface of the individual units of the particles (e.g., individual particles or individual agglomerate particles) is mostly uncontacted, or uncoated, by the (co)polymeric network structure. In this regard, in some embodiments, the average percent areal coverage of the (co)polymeric network structure on the external surface of the individual particles (i.e., the percent of the external surface area that is in direct contact with the (co)polymeric network structure) is not greater than 50 (in some embodiments, not greater than 40, 30, 25, 20, 10, 5, or even not greater than 1) percent, based on the total surface area of the external surfaces of the individual particles. Although not wanting to be bound by theory, it is believed that the large, uncontacted surface area coating on the particles enables increased particle-to-particle contact upon compression and therefore increases thermal conductivity.

In some embodiments, the (co)polymeric network structure does not penetrate internal porosity or internal surface area of the individual particles (e.g., individual particles or individual agglomerate particles) are mostly uncontacted, or uncoated, by the (co)polymeric network structure.

In some embodiments, (co)polymer matrix composites described herein, are in the form of a layer having a thickness in a range from 50 to 11000 micrometers, wherein the thickness excludes the height of any protrusions extending from the base of the layer.

As-made (co)polymer matrix composites described herein (i.e., prior to any compression or other post formation densification), typically have a density of at least 0.3 (in some embodiments, in a range from 0.3 to 5, 0.5 to 4, 0.6 to 3, or even 1.0 to 2.5 g/cm³.

In some embodiments, the thermal conductivity of the (co)polymer matrix composites is improved by compressing the (co)polymer matrix composites thereby increasing the density of the (co)polymer matrix composite. In some embodiments, the compression can take place at elevated temperatures (e.g., above the glass transition temperature of the (co)polymer matrix, or even, in some embodiments, above the melting temperature of the (co)polymer matrix). In some embodiments, (co)polymer matrix composites have a density of at least 1 (in some embodiments, at least 2, 3, 4, 5, 6, 7, 8, 9, or even at least 10; in some embodiments, in the range from 1 to 10, 1 to 9, 3 to 8, or even 4 to 7) g/cm³. In other embodiments, compressed (co)polymer matrix composites typically have a density of at least 0.5 (in some embodiments, in a range from 0.7 to 5, 0.8 to 4, 0.9 to 3, or even 1.0 to 2.5) g/cm³.

In some embodiments, (co)polymer matrix composites described herein have a porosity of at least 5 (in some embodiments, in a range from 10 to 80, 20 to 70, or even 30 to 60) percent.

In some embodiments, (co)polymer matrix composites described herein have a porosity less than 80 (in some embodiments, in a range from 0 to 80, 0 to 70, 0 to 60, 10 to 80, 10 to 70, 10 to 60, 10 to 50, 10 to 40, 10 to 30, or even 5 to 20) percent.

In some exemplary embodiments, the thermally-conductive particles are present in a single layer comprised of the (co)polymer matrix composite. In certain such embodiments, the thermally-conductive particles may be substantially homogenously distributed within the layer.

In other exemplary embodiments, the thermally-conductive particles are present in one or more layers of a multilayer (co)polymer matrix composite. It will be understood that various ordering and arrangements of multiple layers comprising the thermally-conductive particles are within the scope of the present disclosure.

### (Co)Polymers

In some embodiments, the (co)polymeric network structure may comprise, consist essentially of, or consist of at least one thermoplastic (co)polymer. Exemplary thermoplastic (co)polymers include polyurethane, polyester (e.g., polyethylene terephthalate, polybutylene terephthalate, and polylactic acid), polyamide (e.g., nylon 6, nylon 6,6, nylon 12 and polypeptide), polyether (e.g., polyethylene oxide and polypropylene oxide), polycarbonate (e.g., bisphenol-A-polycarbonate), polyimide, polysulphone, polyethersulphone, polyphenylene oxide, polyacrylate (e.g., thermoplastic (co)polymers formed from the addition (co)polymerization of monomer(s) containing an acrylate functional group), poly(meth)acrylate (e.g., thermoplastic (co)polymers formed from the addition (co)polymerization of monomer(s) containing a (meth)acrylate functional group), polyolefin (e.g., polyethylene and polypropylene), styrene and styrene-based random and block copolymer, chlorinated (co)polymer (e.g., polyvinyl chloride), fluorinated (co)polymer (e.g., polyvinylidene fluoride; (co)polymers of tetrafluoroethylene, hexafluoropropylene and vinylidene fluoride; (co)polymers of ethylene, tetrafluoroethylene; hexafluoropropylene; and polytetrafluoroethylene), and (co)polymers of ethylene and chlorotrifluoroethylene.

In some embodiments, thermoplastic (co)polymers include homopolymers or copolymers (e.g., block copolymers or random copolymers). In some embodiments, thermoplastic (co)polymers include a mixture of at least two thermoplastic (co)polymer types (e.g., a mixture of polyethylene and polypropylene or a mixture of polyethylene and polyacrylate). In some embodiments, the (co)polymer may be at least one of polyethylene (e.g., ultra-high molecular weight polyethylene), polypropylene (e.g., ultra-high molecular weight polypropylene), polylactic acid, poly(ethylene-co-chlorotrifluoroethylene) and polyvinylidene fluoride.

In some embodiments, the thermoplastic (co)polymer is a single thermoplastic (co)polymer (i.e., it is not a mixture of at least two thermoplastic (co)polymer types). In some embodiments, the thermoplastic (co)polymers consist essentially of, or consist of polyethylene (e.g., ultra-high molecular weight polyethylene).

In some embodiments, the thermoplastic (co)polymer used to make the (co)polymer matrix composites described herein are particles having a particle size less than 1000 (in some embodiments, in a range from 1 to 10, 10 to 30, 30 to 100, 100 to 200, 200 to 500, 500 to 1000) micrometers.

In some embodiments, the porous (co)polymeric network structure comprises at least one of polyacrylonitrile, polyurethane, polyester, polyamide, polyether, polycarbonate, polyimide, polysulfone, polyphenylene oxide, polyacrylate, poly(meth)acrylate, polyolefin, styrene or styrene-based random and block (co)polymer, chlorinated (co)polymer, fluorinated (co)polymer, or (co)polymers of ethylene and chlorotrifluoroethylene.

In some embodiments, the porous (co)polymeric network structure comprises a (co)polymer having a number average molecular weight in a range from 5×10⁴ to 1×10⁷ (in some embodiments, in a range from 1×10⁶ to 8×10⁶, 2×10⁶ to 6×10⁶, or even 3×10⁶ to 5×10⁶) g/mol. For purposes of the present disclosure, the number average molecular weight can be measured by known techniques in the art (e.g., gel permeation chromatography (GPC)). GPC may be conducted in a suitable nonvolatile diluent for the thermoplastic (co)polymer, along with the use of narrow molecular weight distribution (co)polymer standards (e.g., narrow molecular weight distribution polystyrene standards).

Thermoplastic (co)polymers are generally characterized as being partially crystalline, exhibiting a melting temperature. In some embodiments, the thermoplastic (co)polymer may have a melting temperature in a range from 120 to 350 (in some embodiments, in a range from 120 to 300, 120 to 250, or even 120 to 200) ° C. The melting temperature of the thermoplastic (co)polymer can be measured by known techniques in the art (e.g., the on-set temperature measured in a differential scanning calorimetry (DSC) test, conducted with a 5 to 10 mg sample, at a heating scan rate of 10° C./min., while the sample is under a nitrogen atmosphere).

In certain exemplary embodiments, the (co)polymeric network structure may comprise, consist essentially of, or consist of at least one thermosetting (co)polymer. A thermosetting (co)polymer transforms into a rigid plastic or flexible elastomer by crosslinking or chain extension through the formation of covalent bonds between individual chains of the (co)polymer. Crosslink density varies depending on the monomer or prepolymer mix, and the mechanism of crosslinking:

Thermosetting (meth)acrylic (co)polymers, polyesters and vinyl esters with unsaturated sites at the ends or on the backbone are generally linked by copolymerization with unsaturated monomer diluents, with cure initiated by free radicals generated from ionizing radiation or by the photolytic or thermal decomposition of a radical initiator. The intensity of crosslinking is influenced by the degree of backbone unsaturation in the prepolymer.

Thermosetting epoxy functional (co)polymers can be homo-polymerized with anionic or cationic catalysts and heat, or copolymerized through nucleophilic addition reactions with multifunctional crosslinking agents which are also known as curing agents or hardeners. As reaction proceeds, larger and larger molecules are formed and highly branched crosslinked structures develop, the rate of cure being influenced by the physical form and functionality of epoxy resins and curing agents. Exposure to elevated temperatures induces secondary crosslinking of backbone hydroxyl functionality, which condense to form ether bonds.

Thermosetting polyurethanes form when isocyanate resins and prepolymers are combined with low- or high-molecular weight polyols, with strict stochiometric ratios being essential to control nucleophilic addition polymerization. The degree of crosslinking and resulting physical type (elastomer or plastic) is adjusted from the molecular weight and functionality of isocyanate resins, prepolymers, and the exact combinations of diols, triols and polyols selected, with the rate of reaction being strongly influenced by catalysts and inhibitors.

Polyureas form virtually instantaneously when isocyanate resins are combined with long-chain amine functional polyether or polyester resins and short-chain diamine extenders—the amine-isocyanate nucleophilic addition reaction does not require catalysts. Polyureas also form when isocyanate resins come into contact with moisture.

Thermosetting phenolic, amino and furan resins can be cured by polycondensation involving the release of water and heat, influenced by curing temperature, catalyst selection and/or loading and processing method or pressure. The degree of pre-polymerization and level of residual hydroxymethyl content in the resins determine the crosslink density.

Thermosetting (co)polymer mixtures based on thermosetting resin monomers and pre-polymers can be formulated and applied and processed in a variety of ways to create distinctive cured properties that cannot be achieved with thermoplastic (co)polymers or inorganic materials.

In some embodiments, the (co)polymeric network structure is a continuous network structure (i.e., the (co)polymer phase comprises a structure that is open cell with continuous voids or pores forming interconnections between the voids, extending throughout the structure). In some embodiments, at least 2 (in some embodiments, at least 5, 10, 20, 30, 40, 50, 60, 70, 80, 90, 95, or even, 100) percent of the (co)polymer network structure, by volume, may be a continuous (co)polymer network structure. It should be noted that for purposes of the present disclosure, the portion of the volume of the (co)polymer matrix composite made up of the particles is not considered part of the (co)polymeric network structure. In some embodiments, the (co)polymer network extends between two particles forming a network of interconnected particles.

### Nonvolatile Diluents

The nonvolatile diluent (e.g., a first nonvolatile diluent) is selected such that it forms a miscible (co)polymer-diluent solution. In some cases, elevated temperatures may be required to form the miscible (co)polymer-diluent solution. The nonvolatile diluent may be a single component or a blend of at least two individual nonvolatile diluents.

In some embodiments, particularly when the (co)polymer is a polyolefin (e.g., at least one of polyethylene and polypropylene), the nonvolatile diluent may be, for example, at least one of mineral oil, tetralin, paraffin oil/wax, orange oil, vegetable oil, castor oil, or palm kernel oil. In some embodiments, when the (co)polymer is polyvinylidene fluoride, the nonvolatile diluent may be, for example, at least one of ethylene carbonate, propylene carbonate, or 1,2,3 triacetoxypropane.

In some exemplary embodiments, at least a portion of the nonvolatile diluent remains in the (co)polymer matrix composite. In certain embodiments, substantially all of the nonvolatile diluent remains in the (co)polymer matrix composite. Without wishing to be bound by theory, we believe that the remaining nonvolatile diluent advantageously promotes the wet-out of the interfaces between the formed film (e.g., a thermal interface material) and the heat source and/or the heat sink. The remaining nonvolatile diluent may also act to reduce the thermal resistance caused by the porosity within the formed film. Air has a thermal conductivity of 0.02 W/m° K at room temperature, while mineral oil or paraffin waxes have thermal conductivity values of 0.15 W/m° K and 0.25 W/m° K respectively.

Furthermore, elimination of the requirement to remove a nonvolatile diluent by allowing the nonvolatile diluent to remain in the (co)polymer matrix may reduce the processing costs substantially.

In some embodiments, a portion of the non-volatile diluent may be removed, for example, by extraction. It may be desirable to extract a portion of the nonvolatile diluent, followed by evaporation of the second volatile diluent. For example, in some embodiments, when mineral oil is used as a first nonvolatile diluent, isopropanol at elevated temperature (e.g., about 60° C.) or a blend of methyl nonafluorobutyl ether (C₄F₉OCH₃), ethylnonafluorobutyl ether (C₄F₉OC₂H₅), and trans-1,2-dichloroethylene (available, for example, under the trade designation “NOVEC 72DE” from 3M Company, St. Paul, Minn.) may be used as a second volatile diluent to extract the first nonvolatile diluent, followed by evaporation of the second volatile diluent. In some embodiments, when at least one of vegetable oil or palm kernel oil is used as the first nonvolatile diluent, isopropanol at elevated temperature (e.g., about 60° C.), may be used as the second volatile diluent. In some embodiments, when ethylene carbonate is used as the first nonvolatile diluent, water may be used as the second volatile diluent.

In some embodiments, small quantities of other additives can be added to the (co)polymer matrix composite to impart additional functionality or act as processing aids. These include viscosity modifiers (e.g., fumed silica, block (co)polymers, and wax), plasticizers, thermal stabilizers (e.g., such as available, for example, under the trade designation “IRGANOX 1010” from BASF, Ludwigshafen, Germany), antimicrobials (e.g., silver and quaternary ammonium), flame retardants, antioxidants, dyes, pigments, and ultraviolet (UV) stabilizers.

### Particles

Exemplary thermally conductive particles include conductive carbon, metals, semiconductors, and ceramics.

In some embodiments, the thermally conductive particles comprise electrically non-conductive ceramic particles comprising metal nitrides (e.g., hexagonal boron nitride (h-BN), cubic boron nitride (c-BN), aluminum nitride); metal oxides (e.g., aluminum oxide, beryllium oxide, iron oxide, magnesium oxide, zinc oxide); silicon carbide; silicon nitride, diamonds, aluminum trihydrate, aluminum hydroxide, aluminum oxyhydroxide; natural aluminosilicate and/or synthetic aluminosilicate.

In some embodiments, the thermally conductive particles comprise electrically conductive particles such as carbon particles (e.g., carbon black, graphite and/or graphene); and metal particles comprising at least one metal (e.g., aluminum, copper, nickel, platinum, silver and gold).

In some embodiments, the thermally conductive particles comprise a mixture of two or more particle types selected from carbon black, graphite, graphene, aluminum, copper, silver, graphite, diamond, SiC, Si₃N₄, MN, BeO, MgO, Al₂O₃, aluminum hydroxide, aluminum oxyhydroxide, hexagonal boron nitride (h-BN), cubic boron nitride (c-BN), ZnO, natural aluminosilicate, or synthetic aluminosilicate.

Exemplary sizes of the thermally conductive particles range from 1-100 s of nanometers to 1-100 s of micrometers in size. Exemplary shapes of the thermally conductive particles include irregular, platy, acicular, spherical shapes, and as well as agglomerated forms. Agglomerates can range in size, for example, from a few micrometers up to, and including, a few millimeters. The particles can be mixed to have multimodal size distributions which may, for example, allow for optimal packing density.

In some embodiments, the thermally conductive particles have an average particle size (average length of longest dimension) in a range from 100 nm to 2 mm (in some embodiments, in a range from 200 nm to 1000 nm).

In some embodiments, the thermally conductive particles have bimodal or trimodal distribution. Multimodal distributions of particles can allow for higher packing efficiency, improved particle-to-particle contact and thereby improved thermal conductivity.

### Methods of Making the (Co)Polymer Matrix Composite

Various methods may be used to make the (co)polymer matrix composites of the present disclosure.

### First Method

In another aspect, the present disclosure describes a first method of making (co)polymer matrix composites described herein, the method comprising:

combining (e.g., mixing or blending) a thermoplastic (co)polymer, a nonvolatile diluent, and a plurality of thermally-conductive particles to form a slurry;

forming the slurry into an article (e.g., a layer);

heating the article to a temperature above the melting temperature of the (co)polymer in the nonvolatile diluent in an environment so that the (co)polymer becomes miscible with nonvolatile diluent (e.g., forms a solution of the (co)polymer dissolved in the nonvolatile diluent) while retaining at least 90 (in some embodiments, at least 91, 92, 93, 94, 95, 96, 97, 98, 99, 99.5, or even 100) percent by weight of the nonvolatile diluent in the article, based on the weight of the nonvolatile diluent in the article, and solubilize at least 50 (in some embodiments, at least 55, 60, 65, 70, 75, 80, 85, 90, 95, 96, 97, 98, 99, or even 100) percent of the thermoplastic (co)polymer in the nonvolatile diluent, based on the total weight of the thermoplastic (co)polymer; and

cooling the article to a temperature below the melting temperature of the (co)polymer in the nonvolatile diluent to induce phase separation of the thermoplastic (co)polymer from the nonvolatile diluent to provide the (co)polymer matrix composite containing the thermally-conductive particles and at least a portion of the nonvolatile diluent.

In the first method, the desired article is formed before the (co)polymer becomes miscible with the nonvolatile diluent and the phase separation is a thermally induced phase separation (TIPS) process.

In the TIPS process, elevated temperature is used to make a nonnonvolatile diluent become a nonvolatile diluent for the (co)polymer, then the temperature is lowered returning the nonvolatile diluent to a nonnonvolatile diluent for the (co)polymer. Effectively, the hot nonvolatile diluent becomes the pore former when sufficient heat is removed and it loses its solvating capacity. The nonvolatile diluent used in the thermal phase separation process can be volatile or nonvolatile.

Surprisingly, in the first method to make a (co)polymer matrix composite, the relatively high particle loadings allow a slurry to be made that can be shaped into a layer, that maintains its form as the nonvolatile diluent is heated to become miscible with the (co)polymer. The nonvolatile diluent used is normally volatile and is later evaporated.

Typically, the maximum particle loading that can be achieved in traditional particle-filled composites (dense (co)polymeric films, adhesives, etc.), is not more than about 40 to 60 vol. %, based on the volume of the particles and binder. Incorporating more than 60 vol. % particles into traditional particle-filled composites typically is not achievable because such high particle loaded materials cannot be processed via coating or extrusion methods and/or the resulting composite becomes very brittle.

Traditional composites also typically fully encapsulate the particles with binder, preventing access to the particle surfaces and minimizing potential particle-to-particle contact. Surprisingly, the high levels of nonvolatile diluent and the phase separated morphologies obtained with the methods described herein, enable relatively high particle loadings with relatively low amounts of high molecular weight binder. The through-porous. phase-separated morphologies, also allow samples to be breathable at relatively low to relatively high particle concentrations. The high particle loading also helps minimize the formation of thin non-porous (co)polymer layer that can form during phase separation. Moreover, the (co)polymer matrix composites described herein are relatively flexible, and tend not to shed particles. Although not wanting to be bound by theory, it is believed that another advantage of embodiments of (co)polymer matrix composites described herein, is that the particles are not fully coated with binder enabling a high degree of particle surface contact, without masking due to the porous nature of the binder. It should be noted that compression of the layer can significantly enhance the particle-to-particle contact. The high molecular weight binder also does not readily flow in the absence of nonvolatile diluent, even at elevated temperatures (e.g., 135° C.).

If the thermally-conductive particles are dense, typically the slurry is continuously mixed or blended to prevent or reduce settling or separation of the (co)polymer and/or particles from the nonvolatile diluent. In some embodiments, the slurry is degassed using techniques known in the art to remove entrapped air.

The slurry can be formed in to an article using techniques known in the art, including knife coating, roll coating (e.g., roll coating through a defined nip), and coating through any number of different dies having the appropriate dimensions or profiles.

In some embodiments of the first method, combining is conducted at at least one temperature below the melting temperature of the (co)polymer and below the boiling point of the nonvolatile diluent.

In some embodiments of the first method, heating is conducted at at least one temperature above the melting temperature of the miscible thermoplastic (co)polymer-nonvolatile diluent solution, and below the boiling point of the nonvolatile diluent.

In some embodiments of the first method, inducing phase separation is conducted at a temperature less than the melting temperature of the (co)polymer in the slurry. Although not wanting to be bound, it is believed that in some embodiments, nonvolatile diluents used to make a miscible blend with the (co)polymer can cause melting temperature depression in the (co)polymer. The melting temperature described herein includes below any melting temperature depression of the (co)polymer nonvolatile diluent system.

In some embodiments of the first method, the nonvolatile diluent is a blend of at least two individual nonvolatile diluents. In some embodiments, when the (co)polymer is a polyolefin (e.g., at least one of polyethylene or polypropylene), the nonvolatile diluent may be at least one of mineral oil, tetralin, paraffin oil/wax, orange oil, vegetable oil, castor oil, or palm kernel oil. In some embodiments, when the (co)polymer is polyvinylidene fluoride, the nonvolatile diluent is at least one of ethylene carbonate, propylene carbonate, or 1,2,3 triacetoxypropane.

In some embodiments of the first method, the (co)polymeric network structure may be formed during phase separation. In some embodiments, the (co)polymeric network structure is provided by an induced phase separation of a miscible thermoplastic (co)polymer-nonvolatile diluent solution. In some embodiments, the phase separation is induced thermally (e.g., via thermally induced phase separation (TIPS) by quenching to a lower temperature than used during heating). Cooling can be provided, for example, in air, liquid, or on a solid interface, and varied to control the phase separation. The (co)polymeric network structure may be inherently porous (i.e., have pores). The pore structure may be open, enabling fluid communication from an interior region of the (co)polymeric network structure to an exterior surface of the (co)polymeric network structure and/or between a first surface of the (co)polymeric network structure and an opposing second surface of the (co)polymeric network structure.

In some embodiments of the method described herein, the weight ratio of nonvolatile diluent to (co)polymer is at least 9:1. In some embodiments, the volume ratio of particles to (co)polymer is at least 9:1. In some embodiments, and for ease of manufacturing, it may be desirable to form a layer at room temperature. Typically, during the layer formation using phase separation, relatively small pores are particularly vulnerable to collapsing during nonvolatile diluent extraction. The relatively high particle to (co)polymer loading achievable by the methods described herein may reduce pore collapsing and yield a more uniform defect-free (co)polymer matrix composite.

In some presently-preferred embodiments of the first method, substantially all of the nonvolatile solvent remains in the (co)polymer composite matrix (i.e., no nonvolatile diluent is removed from the formed article, even after inducing phase separation of the thermoplastic (co)polymer from the nonvolatile diluent. This can be accomplished, for example, by adding only a non-volatile diluent (e.g., mineral oil or wax) to the slurry and not completing the extraction/evaporation step.

However, in some embodiments, the first method further comprises removing at least a portion (in some embodiments, at least 1, 2, 3, 4, 5, 10, 15, or even as much as 20 percent by weight of the nonvolatile diluent, based on the weight of the nonvolatile diluent added to the slurry,

In some embodiments. optional volatile components (e.g., volatile solvents) can be removed from the (co)polymer matrix composite, for example, by allowing the volatile component to evaporate from at least one major surface of the (co)polymer matrix composite. Evaporation can be aided, for example, by the addition of at least one of heat, vacuum, or air flow. Evaporation of flammable volatile components can be achieved in a solvent-rated oven. If the first nonvolatile diluent, however, has a low vapor pressure, a second volatile diluent, of higher vapor pressure, may be used to extract the first nonvolatile diluent, followed by evaporation of the second volatile diluent.

For example, in some embodiments, when mineral oil is used as a first nonvolatile diluent, isopropanol at elevated temperature (e.g., about 60° C.) or a blend of methyl nonafluorobutyl ether (C₄F₉OCH₃), ethylnonafluorobutyl ether (C₄F₉OC₂H₅), and trans-1,2-dichloroethylene (available under the trade designation “NOVEC 72DE” from 3M Company, St. Paul, Minn.) may be used as a second volatile diluent to extract the first nonvolatile diluent, followed by evaporation of the second volatile diluent. In some embodiments, when at least one of vegetable oil or palm kernel oil is used as the first nonvolatile diluent, isopropanol at elevated temperature (e.g., about 60° C.) may be used as the second volatile diluent. In some embodiments, when ethylene carbonate is used as the first nonvolatile diluent, water may be used as the second volatile diluent.

### Second Method

In another aspect, the present disclosure describes a second method of making (co)polymer matrix composites described herein, the method comprising:

combining (e.g., mixing or blending) a thermoplastic (co)polymer and a nonvolatile diluent for the thermoplastic (co)polymer to form a mixture,

heating the mixture to a temperature above the melting temperature of the (co)polymer in the nonvolatile diluent to form a miscible thermoplastic (co)polymer-nonvolatile diluent solution;

combining (e.g., mixing or blending) with the solution a plurality of thermally-conductive particles to form a suspension of the thermally-conductive particles in the solution;

forming the suspension into an article (e.g., a layer); and

cooling the article below the melting temperature of the (co)polymer in the nonvolatile diluent and/or removing a portion of the nonvolatile diluent from the article sufficient to induce phase separation of the thermoplastic (co)polymer from the nonvolatile diluent and form the (co)polymer matrix composite containing the thermally-conductive particles and at least a portion of the nonvolatile diluent.

In the second method, the (co)polymer is miscible with the nonvolatile diluent before the desired article is formed. In the second method, phase separation is achieved via thermally induced phase separation methods.

In some embodiments, the second method comprises adding the thermally-conductive particles to the miscible (co)polymer-nonvolatile diluent solution, at any point prior to phase separation. The (co)polymeric network structure may be formed during the phase separation of the process. In some embodiments, the (co)polymeric network structure is provided via an induced phase separation of a miscible thermoplastic (co)polymer-nonvolatile diluent solution.

In some embodiments, the phase separation is induced thermally (e.g., via thermally induced phase separation (TIPS) by quenching to lower temperature), chemically (e.g., via nonvolatile diluent induced phase separation (SIPS) by substituting a poor nonvolatile diluent for a good nonvolatile diluent), or change in the nonvolatile diluent ratio (e.g., by evaporation of one of the nonvolatile diluents).

Other phase separation or pore formation techniques known in the art, such as discontinuous (co)polymer blends (also sometimes referred to as (co)polymer assisted phase inversion (PAPI)), moisture induced phase separation, or vapor induced phase separation, can also be used. The (co)polymeric network structure may be inherently porous (i.e., have pores). The pore structure may be open, enabling fluid communication from an interior region of the (co)polymeric network structure to an exterior surface of the (co)polymeric network structure and/or between a first surface of the (co)polymeric network structure and an opposing second surface of the (co)polymeric network structure.

In some embodiments of the second method, the (co)polymer in the miscible thermoplastic (co)polymer-nonvolatile diluent solution has a melting temperature, wherein the nonvolatile diluent has a boiling point, and wherein combining is conducted at at least one temperature above the melting temperature of the miscible thermoplastic (co)polymer-nonvolatile diluent solution, and below the boiling point of the nonvolatile diluent.

In some embodiments of the second method, the (co)polymer in the miscible thermoplastic (co)polymer-nonvolatile diluent solution has a melting temperature, and wherein inducing phase separation is conducted at at least one temperature less than the melting temperature of the (co)polymer in the miscible thermoplastic (co)polymer-nonvolatile diluent solution. The thermoplastic (co)polymer-nonvolatile diluent mixture may be heated to facilitate the dissolution of the thermoplastic (co)polymer in the nonvolatile diluent. After the thermoplastic (co)polymer has been phase separated from the nonvolatile diluent, at least a portion of the nonvolatile diluent may be removed from the (co)polymer matrix composite using techniques known in the art, including evaporation of the nonvolatile diluent or extraction of the nonvolatile diluent by a higher vapor pressure, second nonvolatile diluent, followed by evaporation of the second nonvolatile diluent.

In some embodiments, in a range from 10 to 100 (in some embodiments, in a range from 20 to 100, 30 to 100, 40 to 100, 50 to 100, 60 to 100, 70 to 100, 80 to 100, 90 to 100, 95 to 100, or even 98 to 100) percent by weight of the nonvolatile diluent, and second nonvolatile diluent, if used, may be removed from the (co)polymer matrix composite.

The nonvolatile diluent is typically selected such that it is capable of dissolving the (co)polymer and forming a miscible (co)polymer-nonvolatile diluent solution. Heating the solution to an elevated temperature may facilitate the dissolution of the (co)polymer. In some embodiments, combining the (co)polymer and nonvolatile diluent is conducted at at least one temperature in a range from 20° C. to 350° C. The thermally-conductive particles may be added at any or all of the combining, before the (co)polymer is dissolved, after the (co)polymer is dissolved, or at any time there between.

In some embodiments, the nonvolatile diluent is a blend of at least two individual nonvolatile diluents. In some embodiments, when the (co)polymer is a polyolefin (e.g., at least one of polyethylene or polypropylene), the nonvolatile diluent may be at least one of mineral oil, paraffin oil/wax, camphene, orange oil, vegetable oil, castor oil, or palm kernel oil. In some embodiments, when the (co)polymer is polyvinylidene fluoride, the nonvolatile diluent is at least one of ethylene carbonate, propylene carbonate, or 1,2,3 triacetoxypropane.

In some embodiments, the nonvolatile diluent may be partially removed, for example, by evaporation, high vapor pressure nonvolatile diluents being particularly suited to this method of removal. If the first nonvolatile diluent, however, has a low vapor pressure, a second volatile diluent, of higher vapor pressure, may be used to extract the first nonvolatile diluent, followed by evaporation of the second volatile diluent. For example, in some embodiments, when mineral oil is used as a first nonvolatile diluent, isopropanol at elevated temperature (e.g., about 60° C.) or a blend of methyl nonafluorobutyl ether (C₄F₉OCH₃), ethylnonafluorobutyl ether (C₄F₉OC₂H₅), and trans-1,2-dichloroethylene (available under the trade designation “NOVEC 72DE” from 3M Company, St. Paul, Minn.) may be used as a second volatile diluent to extract the first nonvolatile diluent, followed by evaporation of the second volatile diluent. In some embodiments, when at least one of vegetable oil or palm kernel oil is used as the first nonvolatile diluent, isopropanol at elevated temperature (e.g., about 60° C.) may be used as the second volatile diluent. In some embodiments, when ethylene carbonate is used as the first nonvolatile diluent, water may be used as the second volatile diluent.

Typically, in the phase separation process, the blended mixture is formed in to a layer prior to solidification of the (co)polymer. The (co)polymer is dissolved in nonvolatile diluent (that allows formation of miscible thermoplastic-nonvolatile diluent solution), and the thermally-conductive particles dispersed to form a blended mixture, that is formed into an article (e.g., a layer), followed by phase separation (e.g., temperature reduction for TIPS, nonvolatile diluent evaporation or nonvolatile diluent exchange with nonnonvolatile diluent for SIPS). The layer-forming may be conducted using techniques known in the art, including, knife coating, roll coating (e.g., roll coating through a defined nip), and extrusion (e.g., extrusion through a die (e.g., extrusion through a die having the appropriate layer dimensions (i.e., width and thickness of the die gap))). In one exemplary embodiment, the mixture has a paste-like consistency and is formed in to a layer by extrusion (e.g., extrusion through a die having the appropriate layer dimensions (i.e., width and thickness of the die gap)).

After forming the slurry into a layer, where the thermoplastic (co)polymer is miscible in its nonvolatile diluent, the (co)polymer is then induced to phase separate. Several techniques may be used to induce phase separation, including at least one of thermally induced phase separation or nonvolatile diluent induced phase separation. Thermally induced phase separation may occur when the temperature at which induced phase separation is conducted is lower than the combining temperature of the (co)polymer, nonvolatile diluent, and thermally-conductive particles. This may be achieved by cooling the miscible (co)polymer-nonvolatile diluent solution, if combining is conducted near room temperature, or by first heating the miscible (co)polymer-nonvolatile diluent solution to an elevated temperature (either during combining or after combining), followed by decreasing the temperature of the miscible (co)polymer-nonvolatile diluent solution, thereby inducing phase separation of the thermoplastic (co)polymer.

In both cases, the cooling may cause phase separation of the (co)polymer from the nonvolatile diluent. Nonvolatile diluent induced phase separation can be conducted by adding a second nonvolatile diluent, a poor nonvolatile diluent for the (co)polymer, to the miscible (co)polymer-nonvolatile diluent solution or may be achieved by removing at least a portion of the nonvolatile diluent of the miscible (co)polymer-nonvolatile diluent solution (e.g., evaporating at least a portion of the nonvolatile diluent of the miscible (co)polymer-nonvolatile diluent solution), thereby inducing phase separation of the (co)polymer. Combination of phase separation techniques (e.g., thermally induced phase separation and nonvolatile diluent induced phase separation), may be employed.

Thermally induced phase separation may be advantageous, as it also facilitates the dissolution of the (co)polymer when combining is conducted at an elevated temperature. In some embodiments, thermally inducing phase separation is conducted at at least one temperature in a range from 5 to 300 (in some embodiments, in a range from 5 to 250, 5 to 200, 5 to 150, 15 to 300, 15 to 250, 15 to 200, 15 to 130, or even 25 to 110) ° C. below the combining temperature.

After inducing phase separation, at least a portion of the nonvolatile diluent may be removed, thereby forming a porous (co)polymer matrix composite layer having a (co)polymeric network structure and a thermally-conductive material distributed within the thermoplastic (co)polymer network structure.

The nonvolatile diluent may be removed by evaporation, high vapor pressure nonvolatile diluents being particularly suited to this method of removal. If the first nonvolatile diluent, however, has a low vapor pressure, a second nonvolatile diluent, of higher vapor pressure, may be used to extract the first nonvolatile diluent, followed by evaporation of the second nonvolatile diluent. In some embodiments, in a range from 10 to 100 (in some embodiments, in a range from 20 to 100, 30 to 100, 40 to 100, 50 to 100, 60 to 100, 70 to 100, 80 to 100, 90 to 100, 95 to 100, or even 98 to 100) percent by weight of the nonvolatile diluent, and second nonvolatile diluent, if used, may be removed from the (co)polymer matrix composite.

### Third Method

In another aspect, the present disclosure describes a third method of making (co)polymer matrix composites described herein, the method comprising:

combining (e.g., mixing or blending) a thermosetting (co)polymer, a plurality of thermally-conductive particles, and a plurality of endothermic particles to provide a slurry or paste;

forming the slurry or paste into an article (e.g., a layer) at temperatures below 100 C (ideally below 25 C). The particle loading is at least 50 (in some embodiments, at least 60, 70, 80, 85, 90 or even at least 95) percent by weight of the article.

In the third method, the slurry or paste is generally mixed, and the desired article is usually formed, at temperatures below the activation temperature of the endothermic particles.

In exemplary embodiments, the cross-linking of the thermosetting polymer may be heat-activated, moisture-activated, catalyst-activated, mixing-activated, or radiation- (e.g., ultraviolet light, visible light, infrared radiation, electron beam radiation, and/or gamma radiation) activated. Ideally, the activation temperature to achieve cross-linking is maintained below the activation temperature of the endothermic particles.

In some embodiments, the high filler loading results into porous composite after forming and cross-linking the article. Although not wanting to be bound by theory, it is believed that another advantage of this porous composites described herein, is that the particles are not fully coated with binder enabling a high degree of particle surface contact, without masking due to the porous nature of the binder.

If the particles are dense, typically the slurry is continuously mixed or blended to prevent or reduce settling or separation of the particles from the (co)polymer. In some embodiments, the slurry or paste is degassed using techniques known in the art to remove entrapped air.

The slurry or paste can be formed in to an article using techniques known in the art, including knife coating, roll coating (e.g., roll coating through a defined nip), and coating through any number of different dies having the appropriate dimensions or profiles.

### Optional Additional Processing Steps

In some embodiments, the first and second methods further comprise compressing the (co)polymer matrix composite. That is, after inducing phase separation, the formed (co)polymeric network structure may be compressed, for example, to tune the air flow resistance of the (co)polymer matrix composite. Compression of the (co)polymer matrix composite may be achieved, for example, by conventional calendaring processes known in the art.

In some embodiments, the percent volume expansion of the (co)polymeric matrix composites is improved by compressing the (co)polymeric matrix composite, thereby increasing the density of the unexpanded (co)polymer matrix composite.

In some embodiments, where the network structure is plastically deformed by at least a compressive force, vibratory energy may be imparted during the application of the compressive force. In some of these embodiments, the (co)polymer composite is in the form of a strip of indefinite length, and the applying of a compressive force step is performed as the strip passes through a nip. A tensile loading may be applied during passage through such a nip. For example, the nip may be formed between two rollers, at least one of which applies the vibratory energy; between a roller and a bar, at least one of which applies the vibratory energy; or between two bars, at least one of which applies the vibratory energy. The applying of the compressive force and the vibratory energy may be accomplished in a continuous roll-to-roll fashion, or in a step-and-repeat fashion. In other embodiments, the applying a compressive force step is performed on a discrete layer between, for example, a plate and a platen, at least one of which applies the vibratory energy. In some embodiments, the vibratory energy is in the ultrasonic range (e.g., 20 kHz), but other ranges are considered to be suitable. For further details regarding plastically deforming the network structure, see co-pending application having U.S. Ser. No. 62/578,732, filed Oct. 30, 2017, the disclosure of which is incorporated by reference.

In some embodiments, the density of the compressed (co)polymer matrix composite is at least 1 (in some embodiments, at least 2.5, or even at least 1.75; in some embodiments, in the range from 1 to 1.75, or even 1 to 2.5) g/cm³ after compression.

In some embodiments, compressing the (co)polymeric matrix composite increases its density by increasing the particle-to-particle contact. This increase in density can increase the amount of thermally-conductive per unit volume.

In some embodiments, (co)polymer matrix composite described herein can be wrapped around a 0.5 mm (in some embodiments, 0.6 mm, 0.7 mm, 0.8 mm, 0.9 mm, 1 mm, 2 mm, 3 mm, 4 mm, 5 mm, 1 cm, 5 cm, 10 cm, 25 cm, 50 cm, or even 1 meter) rod without breaking.

Various unexpected results and advantages are obtained in exemplary embodiments of the disclosure. These and other unexpected results and advantages are within the scope of the following exemplary embodiments.

### Listing of Exemplary Embodiments

1 A. A (co)polymer matrix composite comprising:

a porous (co)polymeric network structure;

a nonvolatile diluent; and

a plurality of thermally-conductive particles distributed within the (co)polymeric network structure, wherein the thermally-conductive particles and thermally-conductive particles are present in a range from 15 to 99 (in some embodiments, in a range from 25 to 98, 50 to 98, 75 to 98, or even 93 to 97) weight percent, based on the total weight of the (co)polymer matrix; and optionally wherein the (co)polymer matrix composite volumetrically expands by at least 10% (in some embodiments at least 20%, 30%, 40% or even 50%) of its initial volume when exposed to a temperature of at least 135 (in some embodiments, at least 150, 175, or even at least 200; in some embodiments, in a range from 135 to 400, or even 200 to 400) ° C.

2A. The (co)polymer matrix composite of Exemplary Embodiment 1A, wherein the (co)polymer matrix composite has a density of at least 0.3 (in some embodiments, in a range from at least 0.3 to 5, 0.4 to 4, 0.5 to 3, or even 1.0 to 2.5) g/cm³.
3A. The (co)polymer matrix composite of any preceding Exemplary Embodiment, wherein the (co)polymer matrix composite has a porosity of at least 5 (in some embodiments, in a range from 10 to 80, 20 to 70, or even 30 to 60) percent.
4A. The (co)polymer matrix composite of any preceding Exemplary Embodiment, wherein the thermally-conductive particles comprise at least one of electrically non-conductive particles or electrically-conductive particles, further wherein the electrically non-conductive particles are ceramic particles selected from the group consisting of boron nitride, aluminum trihydrate, silicon carbide, silicon nitride, metal oxides, metal nitrides, and combinations thereof, and the electrically-conductive particles are metal particles selected from the group consisting of aluminum, copper, nickel, silver, platinum, gold, and combinations thereof.
5A. The (co)polymer matrix composite of any preceding Exemplary Embodiment, wherein the nonvolatile diluent comprises at least one of mineral oil, tetralin, paraffin oil/wax, camphene, orange oil, vegetable oil, castor oil, palm kernel oil, ethylene carbonate, propylene carbonate.
6A. The (co)polymer matrix composite of any preceding Exemplary Embodiment, wherein the thermally-conductive particles are present in a single layer.
7A. The (co)polymer matrix composite of any of Exemplary Embodiments 1A to 5A, wherein (co)polymer matrix is comprised of a plurality of layers, and further wherein the thermally-conductive particles are present in only a portion of the layers.
8A. The (co)polymer matrix composite of any preceding Exemplary Embodiment, wherein the thermally-conductive particles exhibit a number average particle size (average length of longest dimension) in a range from 500 nm to 7000 micrometers (in some embodiments, in a range from 70 micrometers to 300 micrometers, 300 micrometers to 800 micrometers, 800 micrometers to 1500 micrometers, or even 1500 micrometers to 7000 micrometers.
9A. The (co)polymer matrix composite of any preceding Exemplary Embodiment, wherein the thermally-conductive particles are present at a weight fraction in a range from 15 to 99 (in some embodiments, in a range from 25 to 98, 50 to 98, 75 to 98, or even 93 to 97) weight percent, and wherein the thermally-conductive particles are present at a weight fraction in a range from 15 to 99 (in some embodiments, in a range from 25 to 98, 50 to 98, 75 to 98, or even 93 to 97) weight percent, based on the total weight of the (co)polymer matrix composite.
10A. The (co)polymer matrix composite of any preceding Exemplary Embodiment, wherein the porous (co)polymeric network structure comprises at least one of polyurethane, polyester, polyamide, polyether, polycarbonate, polyimide, polysulfone, polyethersulfone, polyphenylene oxide, polyacrylate, poly(meth)acrylate, polyacrylonitrile, polyolefin, styrene or styrene-based random and block (co)polymer, chlorinated (co)polymer, fluorinated (co)polymer, or (co)polymers of ethylene and chlorotrifluoroethylene, polyurea (co)polymers, phenolic (co)polymers, novolac (co)polymers, and silicone (co)polymers.
11A. The (co)polymer matrix composite of any preceding Exemplary Embodiment, wherein the porous (co)polymeric network structure comprises a phase separated plurality of interconnected morphologies (e.g., at least one of fibrils, nodules, nodes, open cells, closed cells, leafy laces, strands, nodes, spheres, or honeycombs).
12A. The (co)polymer matrix composite of any preceding Exemplary Embodiment, wherein the porous (co)polymeric network structure comprises a (co)polymer having a number average molecular weight in a range from of 5×10⁴ to 1×10⁷ (in some embodiments, in a range from 1×10⁶ to 8×10⁶, 2×10⁶ to 6×10⁶, or even 3×10⁶ to 5×10⁶) g/mol.
13A. The (co)polymer matrix composite of any preceding Exemplary Embodiment, wherein the (co)polymer matrix composite is in the form of a layer having a thickness in a range from 50 to 7000 micrometers.
14A. The (co)polymer matrix composite of any preceding Exemplary Embodiment, wherein the porous (co)polymeric network structure is produced by an induced phase separation of a miscible thermoplastic (co)polymer-nonvolatile diluent solution.
15A. The (co)polymer matrix composite of Exemplary Embodiment 14A, wherein induced phase separation is at least one of thermally induced phase separation and nonvolatile diluent induced phase separation.
16A. The (co)polymer matrix composite of any preceding Exemplary Embodiment, having first and second planar, opposed major surfaces.
17A. The (co)polymer matrix composite of any preceding Exemplary Embodiment, having first and second opposed major surfaces, wherein the first major surface is nonplanar (e.g., curved or protrusions with no planar surface there between).
18A. The (co)polymer matrix composite of either Exemplary Embodiment 16A or 17A, wherein the first major surface has first protrusions extending outwardly from the first major surface. In some embodiments, the protrusions are integral with the first major surface.
19A. The (co)polymer matrix composite of Exemplary Embodiment 18A, wherein the first protrusions are at least one of a post, a rail, a hook, a pyramid, a continuous rail, a continuous multi-directional rail, a hemisphere, a cylinder, or a multi-lobed cylinder.
20A. The (co)polymer matrix composite of any of Exemplary Embodiments 16A to 19A, wherein the first major surface has first depressions extending into the first major surface.
21A. The (co)polymer matrix composite of Exemplary Embodiment 20A, wherein the first depressions are at least one of a groove, a slot, an inverted pyramid, a hole (including a thru or blind hole), or a dimple.
22A. The (co)polymer matrix composite of any of Exemplary Embodiments 18A to 21A, wherein the second major surface has second protrusions extending outwardly from the second major surface.
23A. The (co)polymer matrix composite of Exemplary Embodiment 22A, wherein the second protrusions are at least one of a post, a rail, a hook, a pyramid, a continuous rail, a continuous multi-directional rail, a hemisphere, a cylinder, or a multi-lobed cylinder.
24A. The (co)polymer matrix composite of any of Exemplary Embodiments 18A to 23A, wherein the second major surface has second depressions extending into the second major surface.
25A. The (co)polymer matrix composite of Exemplary Embodiment 24A, wherein the second depressions are at least one of a groove, a slot, an inverted pyramid, a hole (including a thru or blind hole), or a dimple.
26A. The (co)polymer matrix composite of any preceding Exemplary Embodiment, further comprising a reinforcement (e.g., attached to the (co)polymer matrix composite, partial therein, and/or therein).

27A. The (co)polymer matrix composite of any preceding Exemplary Embodiment, that can be wrapped around a 0.5 mm (in some embodiments, 0.6 mm, 0.7 mm, 0.8 mm, 0.9 mm, 1 mm, 2 mm, 3 mm, 4 mm, 5 mm, 1 cm, 5 cm, 10 cm, 25 cm, 50 cm, or even 1 meter) rod without breaking.

28A. The (co)polymer matrix composite of any preceding Exemplary Embodiment, comprising at least one of a viscosity modifier (e.g., fumed silica, block (co)polymers, and wax), a plasticizer, a thermal stabilizer (e.g., such as available, for example, under the trade designation “IRGANOX 1010” from BASF, Ludwigshafen, Germany), an antimicrobial (e.g., silver and quaternary ammonium), a flame retardant, an antioxidant, a dye, a pigment, or an ultraviolet (UV) stabilizer.
1B. A method of making the (co)polymer matrix composite of any preceding Exemplary Embodiment, the method comprising:

combining (e.g., mixing or blending) a thermoplastic (co)polymer, a nonvolatile diluent, and a plurality of thermally-conductive particles to form a slurry;

forming the slurry into an article (e.g., a layer);

heating the article to a temperature above the melting temperature of the (co)polymer in the nonvolatile diluent in an environment so that the (co)polymer becomes miscible with the nonvolatile diluent (e.g., forms a solution of the (co)polymer dissolved in the nonvolatile diluent) while retaining at least 90 (in some embodiments, at least 91, 92, 93, 94, 95, 96, 97, 98, 99, 99.5, or even 100) percent by weight of the nonvolatile diluent in the article, based on the weight of the nonvolatile diluent in the article, and solubilize at least 50 (in some embodiments, at least 55, 60, 65, 70, 75, 80, 85, 90, 95, 96, 97, 98, 99, or even 100) percent of the thermoplastic (co)polymer in the nonvolatile diluent, based on the total weight of the thermoplastic (co)polymer; and

cooling the article to a temperature below the melting temperature of the (co)polymer to induce phase separation of the thermoplastic (co)polymer from the nonvolatile diluent to provide the (co)polymer matrix composite containing the thermally-conductive particles and at least a portion of the nonvolatile diluent.

2B. The method of Exemplary Embodiment 1B, further comprising removing a portion (in some embodiments, at least 1, 2.5, 5, 10, 15, 20, 25, 30, 35, or 40 percent by weight) of the nonvolatile diluent, based on the weight of the nonvolatile diluent in the formed article) of the nonvolatile diluent from the formed article after inducing phase separation of the thermoplastic (co)polymer from the nonvolatile diluent.
3B. The method of Exemplary Embodiment 1B, wherein substantially none of the nonvolatile diluent is removed from the formed article (even after inducing phase separation of the thermoplastic (co)polymer from the nonvolatile diluent).
4B. The method of any preceding B Exemplary Embodiment, wherein inducing phase separation includes thermally induced phase separation.
5B. The method of any preceding B Exemplary Embodiment, wherein the (co)polymer in the slurry has a melting temperature, wherein the nonvolatile diluent has a boiling point, and wherein combining is conducted below the melting temperature of the (co)polymer in the slurry, and below the boiling point of the nonvolatile diluent.
6B. The method of any preceding B Exemplary Embodiment, wherein the (co)polymer in the slurry has a melting temperature, and wherein inducing phase separation is conducted at less than the melting temperature of the (co)polymer in the slurry.
7B. The method of any preceding B Exemplary Embodiment, further comprising compressing the (co)polymer matrix composite.
8B. The method of any of Exemplary Embodiments 1B to 9B, further comprising applying vibratory energy to the (co)polymer matrix composite simultaneously with the applying a compressive force.
9B. The method of any preceding B Exemplary Embodiment, wherein the porous (co)polymeric network structure comprises at least one of polyacrylonitrile, polyurethane, polyester, polyamide, polyether, polycarbonate, polyimide, polysulfone, polyethersulfone, polyphenylene oxide, polyacrylate, poly(meth)acrylate, polyolefin, styrene or styrene-based random and block (co)polymer, chlorinated (co)polymer, fluorinated (co)polymer, or (co)polymers of ethylene and chlorotrifluoroethylene, polyurea (co)polymers, phenolic (co)polymers, novolac (co)polymers, and silicone (co)polymers.
10B. The method of any preceding B Exemplary Embodiment, wherein the porous (co)polymeric network structure comprises a plurality of interconnected morphologies (e.g., at least one of fibrils, nodules, nodes, open cells, closed cells, leafy laces, strands, nodes, spheres, or honeycombs).
11B. The method of any preceding B Exemplary Embodiment, wherein the porous (co)polymeric network structure is produced by an induced phase separation of a miscible thermoplastic (co)polymer-nonvolatile diluent solution.
12B. The method of Exemplary Embodiment 11B, wherein inducing phase separation includes thermally induced phase separation.
1C. A method of making the (co)polymer matrix composite of any preceding A Exemplary Embodiment, the method comprising:

combining (e.g., mixing or blending) a thermoplastic (co)polymer and a nonvolatile diluent for the thermoplastic (co)polymer to form a mixture, heating the mixture to a temperature above the melting temperature of the (co)polymer in the nonvolatile diluent to form a miscible thermoplastic (co)polymer-nonvolatile diluent solution;

combining with the solution a plurality of thermally-conductive particles to form a suspension of the thermally-conductive particles in the solution;

forming the suspension into an article (e.g., a layer); and

cooling the article below the melting temperature of the (co)polymer in the nonvolatile diluent and/or removing a portion of the nonvolatile diluent from the article sufficient to induce phase separation of the thermoplastic (co)polymer from the nonvolatile diluent and form the (co)polymer matrix composite containing the thermally-conductive particles and at least a portion of the nonvolatile diluent.

2C. The method of Exemplary Embodiment 1C, wherein inducing phase separation includes at least one of thermally induced phase separation or nonvolatile diluent induced phase separation.
3C. The method of Exemplary Embodiment 1C, wherein the (co)polymer in the miscible thermoplastic (co)polymer-nonvolatile diluent solution has a melting temperature, wherein the nonvolatile diluent has a boiling point, and wherein combining is conducted above the melting temperature of the miscible thermoplastic (co)polymer-nonvolatile diluent solution, and below the boiling point of the nonvolatile diluent.
4C. The method of any preceding C Exemplary Embodiment, wherein the (co)polymer in the miscible thermoplastic (co)polymer-nonvolatile diluent solution has a melting temperature, and wherein inducing phase separation is conducted at less than the melting temperature of the (co)polymer in the miscible thermoplastic (co)polymer-nonvolatile diluent solution.
5C. The method of any preceding C Exemplary Embodiment, further comprising compressing the (co)polymer matrix composite.
6C. The method of any of Exemplary Embodiments 1C to 4C, further comprising applying vibratory energy to the (co)polymer matrix composite simultaneously with the applying a compressive force.
7C. The method of any preceding C Exemplary Embodiment, wherein the porous (co)polymeric network structure comprises at least one of polyacrylonitrile, polyurethane, polyester, polyamide, polyether, polycarbonate, polyimide, polysulfone, polyethersulfone, polyphenylene oxide, poly(meth)acrylate, poly(meth)acrylate, polyolefin, styrene or styrene-based random and block (co)polymer, chlorinated (co)polymer, fluorinated (co)polymer, or (co)polymers of ethylene and chlorotrifluoroethylene, polyurea (co)polymers, phenolic (co)polymers, novolac (co)polymers, and silicone (co)polymers.
8C. The method of any preceding C Exemplary Embodiment, wherein the porous (co)polymeric network structure comprises a plurality of interconnected morphologies (e.g., at least one of fibrils, nodules, nodes, open cells, closed cells, leafy laces, strands, nodes, spheres, or honeycombs).
1D. An article (e.g., a thermal interface material, a thermally initiated fuse and/or a fire-stop device) comprising the (co)polymer matrix composite of any preceding A Exemplary Embodiment.

Various advantages and embodiments are further illustrated by the following examples, but the particular materials and amounts thereof recited in these examples, as well as other conditions and details, should not be construed to unduly limit this invention. All parts and percentages are by weight unless otherwise indicated.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Test Methods

### Density and Porosity Test

The density of a sample was calculated using a method similar to ASTM F-1315-17 (2017), “Standard Test Method for Density of a Sheet Gasket Material,” the entire disclosure of which is incorporated herein by reference, by cutting a 47 mm diameter disc, weighing the disc on an analytical balance of suitable resolution (typically 0.0001 gram), and measuring the thickness of the disc on a thickness gauge (obtained as Model 49-70 from Testing Machines, Inc. (New Castle, Del.) with a dead weight of 7.3 psi (50.3 KPa) and a flat anvil of 0.63 inch (1.6 cm) diameter, with a dwell time of about 3 seconds and a resolution of +/−0.0001 inch. The density was then calculated by dividing the mass by the volume, which was calculated from the thickness and diameter of the sample. With the known densities and weight fractions of the components of the (co)polymer matrix composite, the theoretical density of the (co)polymer matrix composite was calculated by the rule of mixtures. Using the theoretical density and the measured density, the porosity was calculated as:

Porosity=[1−(measured density/theoretical density)]×100.

### Thermal Conductivity Test

The thermal conductivity of the films was measured according to ASTM D5470 (“Standard Test Method for Thermal Transmission Properties of Thermally Conductive Electrical Insulation Materials”), the entire disclosure of which is incorporated herein by reference, using the Thermal Interface Material Tester Model TIM1300 from AnalysisTech (Wakefield, Mass.). 33 mm discs were cut out of the densified squares using a hole punch. The test temperature was 50° C. and the applied test pressure was set to 100 psi (689.5 kPa). The instruments' thickness gauge was used to measure the thickness of the sample during testing. A thin layer of thermal grease (Thermal Grease 120 Series, Wakefield Thermal Solutions (Pelham, N.H.) is applied to the samples before placing them into the TIM tester to reduce the contact resistance between test surfaces and sample surfaces (increased surface wet-out).

### Cross-Section Inspection Test

A scanning electron microscope (SEM) digital image of a cross-section of the polymer matrix composites were taken with an SEM (obtained under the trade designation “PHENOM” from FEI Company (Hillsboro, Oreg.). The cross-sectional sample was prepared by liquid nitrogen freeze fracturing followed by gold sputter coating with a sputter coater (obtained under the trade designation “EMITECH K550X” from Quorum Technologies (Laughton East Sussex, England).

### EXAMPLE ARTICLES

### Example 1A

A plastic mixing cup (obtained under the trade designation “MAX 300 LONG CUP” for a speed mixer obtained under the trade designation “SPEEDMIXER DAC600.2 VAC-LR,” both from FlackTek, Inc. (Landrum, S.C.) was charged with 8.1 grams of an ultra-high molecular weight polyethylene (UHMWPE) (obtained under the trade designation “GUR-2126” from Celanese Corporation, Irving, Tex.), 192.0 grams of aluminum particles (obtained under the trade designation “ALUMINUM SHOTS RSA400-2N” from Transmet Corporation (Columbus, Ohio), and 32.0 grams of paraffin (obtained under the trade designation “ISOPAR G” from Brenntag Great Lakes, Inc. (Wauwatosa, Wis.). The materials were mixed at 1000 rpm for 30 seconds, followed by 1200 rpm for 30 seconds, followed by 800 rpm for 60 seconds. The mixing was done under vacuum at 50 mBar.

The slurry was removed from the mixer, stirred by hand to remove material from the walls of the cup and then applied with a scoop at room temperature (about 25° C.) to a 3 mil (75 micrometer) heat stabilized biaxially-oriented polyethylene terephthalate (PET) liner, and then to a 3 mil (75 micrometer) heat stabilized biaxially-oriented PET liner was applied on top to sandwich the slurry. The selection of a specific heat stabilized biaxially-oriented PET liner is not critical.

The slurry was spread between the PET liners by using a notch bar set to a gap of 66 mils (1.68 mm). The notch bar rails were wider than the PET liner to obtain an effective wet film thickness of approximately 60 mils (1.52 mm). Progressive multiple passes with increasing downward pressure of the notch bar were used to flatten the slurry. The sandwiched, formed slurry was placed on an aluminum tray and placed in a lab oven (obtained under the trade designation “DESPATCH RFD1-42-2E” from Despatch, Inc. (Minneapolis, Minn.), at 135° C. (275° F.) for 5 minutes to activate (i.e., to allow the UHMWPE to dissolve into the nonvolatile diluent forming a single phase).

The tray with the activated, sandwiched, formed slurry was removed from the oven and allowed to air cool to ambient temperature, forming a nonvolatile diluent filled polymer matrix composite. Both the top and bottom liners were removed exposing the polymer matrix composite to air. The polymer matrix composite was then placed back on a heat stabilized biaxially-oriented PET liner on the tray and the tray was inserted into the lab oven (“DESPATCH RFD1-42-2E”) from Despatch, Inc. (Minneapolis, Minn.) at 100° C. (215° F.) for 30 min. After evaporation, the polymer matrix composite was removed from the oven, allowed to cool to ambient temperature, and characterized.

The resulting polymer matrix composite was 56.7 mils (1.44 mm) thick (as determined in the “Density and Porosity Test”).

### Example 1B

Example 1B was prepared as described in Example 1A. A 1.5″×1.5″ square was cut from the film. The square was placed between two release liners, and then between two sheet metal plates. This layup was placed in a hydraulic press (obtained under the trade designation “WABASH-GENESIS MODEL G30H-15-LP” from Wabash MPI (Wabash, Ind.) and compressed at 15 tons at ambient temperature (about 25° C.) for 60 seconds.

The resulting polymer matrix composite was 48.0 mils (1.22 mm) thick (as determined in the “Density and Porosity Test”)and had a measured thermal conductivity of 2.59 W/m° K (as determined by the “Thermal Conductivity Test”).

### Example 1C

Example 1C was prepared as described in Example 1B, except a thin layer of thermal grease (obtained under the trade designation “THERMAL GREASE 120 SERIES” from Wakefield Thermal Solutions (Pelham, N.H.) was applied to both sides of the sample using the “Thermal Conductivity Test” method to reduce the surface contact resistance during testing.

The resulting polymer matrix composite was 48.0 mils (1.22 mm) thick (as determined in the “Density and Porosity Test”) and had a measured thermal conductivity of 3.70 W/m° K (as determined by the “Thermal Conductivity Test”).

### Example 2A

A plastic mixing cup (obtained under the trade designation “MAX 300 LONG CUP” for a speed mixer obtained under the trade designation “SPEEDMIXER DAC600.2 VAC-LR,” both from FlackTek, Inc. (Landrum, S.C.) was charged with 8.1 grams of an ultra-high molecular weight polyethylene (UHMWPE) (obtained under the trade designation “GUR-2126” from Celanese Corporation (Irving, Tex.), 192.1 grams of aluminum particles (obtained under the trade designation “ALUMINUM SHOTS RSA400-2N” from Transmet Corporation (Columbus, Ohio), and 31.2 grams of mineral oil (obtained under the trade designation “KAYDOL”, Product Number 637760, from Brenntag Great Lakes Inc. (Wauwatosa, Wis.). The materials were mixed at 1000 rpm for 30 seconds, followed by 1200 rpm for 30 seconds, followed by 800 rpm for 60 seconds. The mixing was done under vacuum at 50 mBar.

The slurry was removed from the mixer, stirred by hand to remove material from the walls of the cup and then applied with a scoop at room temperature (about 25° C.) to a 3-mil (75-micrometer) heat stabilized biaxially-oriented PET liner then a 3 mil (75 micrometer) heat stabilized biaxially-oriented PET liner was applied on top to sandwich the slurry.

The slurry was spread between the PET liners by using a notch bar set to a gap of 66 mils (1.68 mm). The notch bar rails were wider than the PET liner to obtain an effective wet film thickness of approximately 60 mils (1.52 mm). Progressive multiple passes with increasing downward pressure of the notch bar were used to flatten the slurry. The sandwiched, formed slurry was placed on an aluminum tray and placed in a lab oven (obtained under the trade designation “DESPATCH RFD1-42-2E” from Despatch, Inc. (Minneapolis, Minn.)), at 135° C. (275° F.) for 5 minutes to activate (i.e., to allow the UHMWPE to dissolve into the nonvolatile diluent forming a single phase). The tray with the activated, sandwiched, formed slurry was removed from the oven and allowed to air cool to ambient temperature (about 25° C.), forming a nonvolatile diluent filled polymer matrix composite. Both the top and bottom liners were removed exposing the polymer matrix composite to air.

The resulting polymer matrix composite was 53.9 mils (1.37 mm) thick (as determined in the “Density and Porosity Test”) and had a density of 1.819 g/cm3 (as determined by the “Density and Porosity Test”).

### Example 2B

Example 2B was prepared as described in Example 2A. A 1.5″×1.5″ square was cut from the film. The square was placed between two release liners, and then between two sheet metal plates. This layup was placed in a hydraulic press (obtained under the trade designation “WABASH-GENESIS MODEL G30H-15-LP” from Wabash MPI (Wabash, Ind.) and compressed at 15 tons at ambient temperature (about 25° C.) for 60 seconds.

The resulting polymer matrix composite was 34.9 mils (0.89 mm) thick and had a density of 1.872 g/cm3 (as determined in the “Density and Porosity Test”), and had a measured thermal conductivity of 3.55 W/m° K (as determined by the “Thermal Conductivity Test”).

### Example 2C

Example 2C was prepared as described in Example 2B, except a thin layer of thermal grease (obtained under the trade designation “THERMAL GREASE 120 SERIES” from Wakefield Thermal Solutions (Pelham, N.H.) was applied to both sides of the sample using the “Thermal Conductivity Test” method to reduce the surface contact resistance during testing.

The resulting polymer matrix composite was 34.9 mils (0.89 mm) thick and had a density of 1.872 g/cm3 (as determined by the “Density and Porosity Test”), and had a thermal conductivity of 3.61 W/m° K (as determined by the “Thermal Conductivity Test”).

### Example 3A

A 300 ml aluminum mixing cup was charged with 35.0 grams of wax paraffin (obtained under the trade designation WAX PARAFFIN W1018 from Spectrum Chemical Mfg. Corp. (Gardena, Calif.). The aluminum jar was placed on a hot plate (obtained under the trade designation “RCTBASIC” from IKA Works, Inc. (Wilmington, N.C.) for 15 min to heat the material to 160° F. (71° C.). Next, 11.2 grams of an ultra-high molecular weight polyethylene (UHMWPE) (obtained under the trade designation “GUR-2126” from Celanese Corporation, Irving, Tex.) and 211.0 grams of aluminum particles (obtained under the trade designation “ALUMINUM SHOTS RSA400-2N” from Transmet Corporation (Columbus, Ohio) were added to the aluminum jar. The materials were mixed by hand using a tongue depressor for 3 min while the jar remained on the hot plate.

The resulting slurry was dispensed into a plastic cup (obtained under the trade designation “MAX 300 LONG CUP” for a speed mixer obtained under the trade designation “SPEEDMIXER DAC600.2 VAC-LR,” both from FlackTek, Inc. (Landrum, S.C.) and mixed at 1200 RPM for 30 seconds under vacuum at 50 mBar.

A 3 mil (75 micrometers) heat stabilized biaxially-oriented PET liner was placed onto a 78.74 mil (2 mm) aluminum plate. The aluminum plate with the PET liner was placed on top of a hot plate (obtained under the trade designation “RCTBASIC” from IKA Works, Inc. (Wilmington, N.C.) to preheat both to 160° F. (71° C.).

The slurry was cast onto the PET liner while still hot, then another 3 mil (75 micrometer) PET liner was placed on top to sandwich the slurry. The slurry was spread between the PET liners by using a notch bar set to a gap of 66 mils (1.68 mm). The notch bar rails were wider than the PET liner to obtain an effective wet film thickness of approximately 75 mils (1.91 mm). Progressive multiple passes with increasing downward pressure of the notch bar were used to flatten the slurry. The sandwiched, formed slurry was placed on an aluminum tray and placed in a lab oven (obtained under the trade designation “DESPATCH RFD1-42-2E” from Despatch, Inc. (Minneapolis, Minn.) at 135° C. (275° F.) for 5 minutes to activate (i.e., to allow the UHMWPE to dissolve into the nonvolatile diluent forming a single phase). After activation, the films were removed from the oven and cooled down to ambient temperature.

The resulting polymer matrix composite was 73.2 mils (1.86 mm) thick and had a density of 2.231 g/cm3 (as determined by the “Density and Porosity Test”).

### Example 3B

Example 3B was prepared as described in Example 3. A 1.5″×1.5″ square was cut from the film. The square was placed between two release liners, and then between two sheet metal plates. This layup was placed in a hydraulic press (obtained under the trade designation “WABASH-GENESIS MODEL G30H-15-LP” from Wabash MPI (Wabash, Ind.) and compressed at 15 tons (147 kN) at ambient temperature (about 25° C.) for 60 seconds.

The resulting polymer matrix composite was 55.0 mils (1.40 mm) thick and had a density of 2.332 g/cm3 (as determined by the “Density and Porosity Test”), and had a measured thermal conductivity of 6.05 W/m° K (as determined by the “Thermal Conductivity Test”).

### Example 3C

Example 3C was prepared as described in Example 3B, except a thin layer of thermal grease (obtained under the trade designation “THERMAL GREASE 120 SERIES” from Wakefield Thermal Solutions (Pelham, N.H.) was applied to both sides of the sample using the “Thermal Conductivity Test” method to reduce the surface contact resistance during testing.

The resulting polymer matrix composite was 55.0 mils (1.40 mm) thick and had a conductivity of 5.93 W/m° K (as determined by the “Thermal Conductivity Test”).

### Example 4A

Mineral oil (obtained under the trade designation “KAYDOL” (Product Number 637760) from Brenntag Great Lakes Inc. (Wauwatosa, Wis.) along with alumina particles (obtained under the trade designation “TM1250” from Huber Engineered Materials (Atlanta, Ga.) and an ultra-high molecular weight polyethylene (UHMWPE) (obtained under the trade designation “GUR-2126” from Celanese Corporation (Irving, Tex.) were individually weighed to give the following weight ratios of 52.5 wt % mineral oil, 45.6 wt % alumina particles, and 1.9 wt % UHMWPE. Mineral oil and UHMWPE were then dispensed in to the mixing bowl of a Double Planetary Mixer DPM-4 from Charles Ross & Sons Company (Hauppauge, N.Y.) and mixed for 3 minutes at 35 rpm. The mixing bowl was then removed, and the alumina particles were added, followed by mixing at 35 rpm for 10 minutes, and finally mixing at 35 rpm for 10 minutes under 23 inches of Hg (779 mBar) vacuum to remove air bubbles. The blend was then discharged into a 5 gallon (19.5 liter) pail.

Using a pail loader pump with a flow control plate (obtained under the trade designation “X20” from Graco Inc. (Minneapolis, Minn.), the blend was fed into the open barrel zone #2 of a 25 mm co-rotating twin-screw extruder with an L/D ratio of 34 (obtained under the trade name “ZE25” from Berstorff (Munich, Germany) at about 180° C. The extruder fed an 8 inch (20.3 cm) drop die (obtained from Nordson Extrusion Die Industries (Chippewa Falls, Wis.), which was maintained at 177° C.

The hot film coming from the die was quenched on a smooth casting wheel at 24° C. The speed of the casting wheel was adjusted to produce films having varying thicknesses, from about 0.5 mm to 0.6 mm thick.

### Example 4B

Example 4B was prepared as described in Example 4. A 38 mm by 38 mm square was cut out from the quenched film. This square was placed between two release liners and then the sandwich was placed between to pieces of sheet metal. The stack was placed in a hydraulic press (obtained under the trade designation “WABASH-GENESIS MODEL G30H-15-LP” from Wabash MPI (Wabash, Ind.) and compressed at 15 tons (147 kN) at ambient temperature (about 25° C.) for 60 seconds.

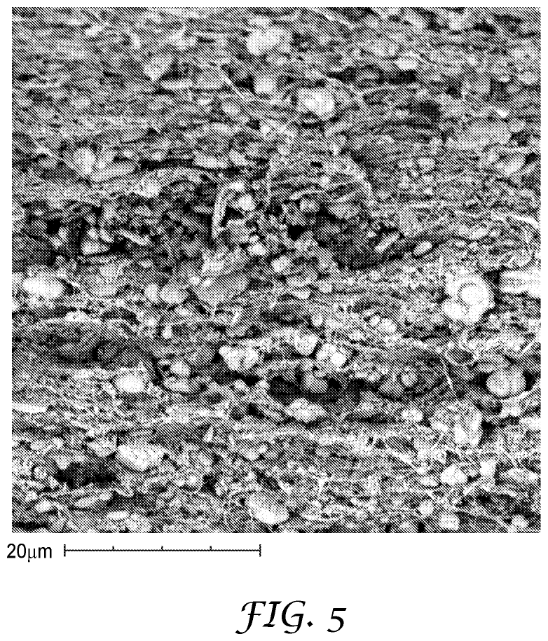

The resulting densified polymer matrix composite was 8.02 mils (0.20 millimeter) thick and had a density of 1.63 g/cm³ (as determined by the “Density and Porosity Test”), and a thermal conductivity of 0.695 W/m° K (as determined by the “Thermal Conductivity Test”). Referring to FIG. 5, a photomicrograph obtained using the Cross-section Inspection Test on the (co)polymer matrix composite is shown.

### Example 4C

Example 4C was prepared as described in Example 4B. The mineral oil in the film was then extracted by soaking the 33 mm disc in 200 mL of an engineered fluid (obtained under the trade designation “NOVEC 72DE” from 3M Company (St. Paul, Minn.) for 10 minutes and repeating for a total of three soakings with fresh nonvolatile diluent.

The resulting washed, densified, polymer matrix composite was 6.1 mils (0.16 millimeter) thick and had a density of 1.527 g/cm³ (as determined by the “Density and Porosity Test”), and a thermal conductivity of 0.485 W/m° K (as determined by the “Thermal Conductivity Test”).

### Example 5A

Example 5A was made and processed in the same manner as example 4B, except that when tested for thermal conductivity, thermal grease was applied to both surfaces of the 33 mm disc before inserting into the TIM tester as described in the Thermal Conductivity Test.

The resulting densified polymer matrix composite was 7.4 mils (0.19 millimeter) thick and had a density of 1.83 g/cm³ (as determined by the “Density and Porosity Test”), and a thermal conductivity of 0.723 W/m° K (as determined by the “Thermal Conductivity Test”) with thermal grease.

### Example 5B

Example 5B was made and processed in the same manner as example 4C, except that when tested for thermal conductivity, thermal grease was applied to both surfaces of the 33 mm disc before inserting into the TIM tester as described in the Thermal Conductivity Test.

The resulting washed, densified, polymer matrix composite was 5.7 mils (0.15 millimeter) thick and had a density of was 1.72 g/cm³ (as determined by the “Density and Porosity Test”), and a thermal conductivity of 1.23 W/m° K (as determined by the “Thermal Conductivity Test”) without use of thermal grease. The resulting increase in thermal conductivity is thought to be from the thermal grease filling the pores of this thin sample, thereby increasing the thermal conductivity.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

What is claimed is:

1. A (co)polymer matrix composite comprising:
a porous (co)polymeric network structure;
a nonvolatile diluent, and
a plurality of thermally-conductive particles distributed within the (co)polymeric network structure, wherein the thermally-conductive particles and the thermally-conductive particles are present in a range from 15 to 94 weight percent of the (co)polymer matrix composite, optionally wherein the (co)polymer matrix composite volumetrically expands by at least 10% of an initial volume when exposed to a temperature of at least 135° C.

2. The (co)polymer matrix composite of claim 1, wherein the (co)polymer matrix composite has a density of at least 0.3 g/cm³, or a porosity of at least 5 percent.

3. The (co)polymer matrix composite of claim 1, wherein the thermally-conductive particles comprise at least one of electrically non-conductive particles or electrically-conductive particles, further wherein the electrically non-conductive particles are ceramic particles selected from the group consisting of boron nitride, aluminum trihydrate, silicon carbide, silicon nitride, metal oxides, metal nitrides, and combinations thereof, and the electrically-conductive particles are carbon particles, graphite particles, graphene particles, or metal particles selected from the group consisting of aluminum, copper, nickel, silver, platinum, gold, and combinations thereof, additionally wherein the nonvolatile diluent is at least one of at least one of mineral oil, tetralin, paraffin oil/wax, camphene, orange oil, vegetable oil, castor oil, palm kernel oil, ethylene carbonate, propylene carbonate, or 1,2,3 triacetoxypropane.

4. The (co)polymer matrix composite of claim 1, wherein the thermally-conductive particles have a number average particle diameter in a range from 500 nanometers to 7000 micrometers.

5. The (co)polymer matrix composite of claim 1, wherein the porous (co)polymeric network structure comprises at least one of polyurethane, polyester, polyamide, polyether, polycarbonate, polyimide, polysulfone, polyethersulfone, polyphenylene oxide, polyacrylate, poly(meth)acrylate, polyacrylonitrile, polyolefin, styrene or styrene-based random and block (co)polymer, chlorinated (co)polymer, fluorinated (co)polymer, or (co)polymers of ethylene and chlorotrifluoroethylene, polyurea (co)polymers, phenolic (co)polymers, novolac (co)polymers, and silicone (co)polymers.

6. A method of making the (co)polymer matrix composite of claim 1, the method comprising:
combining a thermoplastic (co)polymer, a nonvolatile diluent, and a plurality of thermally-conductive particles to form a slurry;
forming the slurry into an article;
heating the article to a temperature above the melting temperature of the (co)polymer in the nonvolatile diluent in an environment so that the nonvolatile diluent solubilize at least 50 percent by weight of the thermoplastic (co)polymer in the nonvolatile diluent and becomes miscible with the nonvolatile diluent, while retaining at least 90 percent by weight of the nonvolatile diluent in the article; and
cooling the article to a temperature below the melting temperature of the (co)polymer in the nonvolatile diluent to induce phase separation of the thermoplastic (co)polymer from the nonvolatile diluent to produce the (co)polymer matrix composite containing the thermally-conductive particles and at least a portion of the nonvolatile diluent.

7. The method of claim 6, further comprising removing a portion of the nonvolatile diluent from the formed article after inducing phase separation of the thermoplastic (co)polymer from the nonvolatile diluent.

8. The method of claim 6, wherein substantially no nonvolatile diluent is removed from the formed article.

9. The method of claim 6, wherein inducing phase separation includes thermally induced phase separation.

10. The method of claim 6, wherein the nonvolatile diluent has a boiling point, and wherein combining is conducted below the melting temperature of the (co)polymer in the nonvolatile diluent, and below the boiling point of the nonvolatile diluent.

11. The method of claim 6, wherein inducing phase separation is conducted at less than the melting temperature of the (co)polymer in the nonvolatile diluent.

12. The method of claim 6, further comprising compressing the (co)polymer matrix composite.

13. The method of claim 6, further comprising applying vibratory energy to the (co)polymer matrix composite simultaneously with the applying a compressive force.

14. A method of making the (co)polymer matrix composite of claim 1, the method comprising:
combining a thermoplastic (co)polymer and a nonvolatile diluent for the thermoplastic (co)polymer to form a mixture,
heating the mixture to a temperature above a melting temperature of the (co)polymer in the nonvolatile diluent so that the nonvolatile diluent solubilize at least 50 percent by weight of the thermoplastic (co)polymer in the nonvolatile diluent and becomes miscible with the nonvolatile diluent;
combining with the solution a plurality of thermally-conductive particles to form a suspension of the thermally-conductive particles in the solution;
forming the suspension into an article (e.g., a layer); and
cooling the article below the melting temperature of the (co)polymer in the nonvolatile diluent and/or removing a portion of the nonvolatile diluent from the article sufficient to induce phase separation of the thermoplastic (co)polymer from the nonvolatile diluent and form the (co)polymer matrix composite containing the thermally-conductive particles and at least a portion of the nonvolatile diluent.

15. The method of claim 14, wherein inducing phase separation includes at least one of thermally induced phase separation or nonvolatile diluent induced phase separation.

16. The method of claim 14, wherein the nonvolatile diluent has a boiling point, and wherein combining is conducted above the melting temperature of the (co)polymer in the nonvolatile diluent, and below the boiling point of the nonvolatile diluent.

17. The method of claim 14, wherein inducing phase separation is conducted at less than the melting temperature of the (co)polymer in the nonvolatile diluent.

18. The method of claim 14, further comprising compressing the (co)polymer matrix composite.

19. The method of claim 14, further comprising applying vibratory energy to the (co)polymer matrix composite simultaneously with the applying a compressive force.

20. An electronic article comprising the (co)polymer matrix composite of claim 1, optionally wherein the electronic article comprises a mobile handheld electronic device, a power supply, a battery, a motor, or a combination thereof.
